(19) United States
(12) Patent Application Publication
(10) Pub. No.: US 2026/0079414 A1
(43) Pub. Date: Mar. 19, 2026

(54) ELECTROPHOTOGRAPHIC APPARATUS

(71) Applicant: CANON KABUSHIKI KAISHA, Tokyo (JP)

(72) Inventors: FUMIYUKI HIYAMA, Shizuoka (JP); AKIHIRO MARUYAMA, Shizuoka (JP); CHIHARU AKIYAMA, Shizuoka (JP); TSUTOMU NISHIDA, Shizuoka (JP)

(21) Appl. No.: 19/318,782

(22) Filed: Sep. 4, 2025

(30) Foreign Application Priority Data
Sep. 13, 2024 (JP) 2024-159483

(51) Int. Cl. G03G 5/05; G03G 5/06; G03G 15/02

(52) U.S. Cl. CPC G03G 5/056; G03G 5/0605; G03G 5/0696; G03G 5/0698; G03G 15/0291

(57) ABSTRACT

Provided is an electrophotographic apparatus including: an electrophotographic photosensitive member; and a corona charger configured to positively charge the electrophotographic photosensitive member. The electrophotographic photosensitive member includes a monolayer type photosensitive layer. The photosensitive layer contains a charge generating substance, a hole transporting substance, an electron transporting substance, and a binder resin. The binder resin contains a polyester resin having a specific structural unit.

### BACKGROUND

### Field of the Technology

The present disclosure relates to an electrophotographic apparatus.

### Description of the Related Art

An electrophotographic photosensitive member (hereinafter sometimes referred to as “photosensitive member”) is used as an image bearing member in an electrophotographic image forming apparatus (e.g., a printer or a multifunction peripheral) (hereinafter sometimes referred to as “electrophotographic apparatus”).

In an image forming apparatus using an electrophotographic method typified by a copying machine or a printer, a photosensitive member is uniformly subjected to primary charging to a predetermined polarity, and image exposure is performed by irradiation with light based on predetermined image information to form an electrostatic latent image. Subsequently, the electrostatic latent image is developed by a developing method such as a contact developing method to form a toner image on the surface of an image bearing member. The toner image thus formed on the surface of the image bearing member is transferred to a transfer sheet by utilizing an electrostatic force with a transfer roller or a corona charger for transfer. The transfer sheet having the toner image transferred thereto is introduced into a fixing device, and the toner image is fixed to the surface of the transfer sheet with heat and pressure, to thereby perform image formation.

In the above-mentioned image forming apparatus, a corona charger is widely adopted as a charging device to be used for charging the photosensitive member. In corona charging, a charging member is not in contact with the photosensitive member. Thus, the charging member is not contaminated even at the time of long-term repeated use, and uniform charging can be achieved. As a result, high image quality can be achieved even at the time of long-term repeated use. However, the corona charging has drawbacks in that, for example, discharge products, such as ozone, NOx, and ions, are generated through the charging mechanism thereof, and the discharge products accelerate the deterioration of the photosensitive member.

As an electrophotographic photosensitive member, for example, a monolayer type electrophotographic photosensitive member and a laminate type electrophotographic photosensitive member are used. The monolayer type electrophotographic photosensitive member includes a monolayer type photosensitive layer having a function of charge generation and a function of charge transportation. An electrophotographic photosensitive member including a monolayer type photosensitive layer has features such that the production cost is lower than that of an electrophotographic photosensitive member including a laminate type photosensitive layer because of the simple layer structure, and an increase in resolution is excellent because charge is generated in the vicinity of the surface of the photosensitive layer.

However, the monolayer type photosensitive member has the following problems. As described above, the monolayer type photosensitive member has a charge generating substance in the vicinity of the surface and is hence susceptible to the influence of a gas component and an ion component. In combination with corona charging, the photosensitive layer gradually deteriorates, and hence the stability of a potential at the time of long-term repeated use is low.

In Japanese Patent Laid-Open No. 2020-118706, there is a description that the deterioration of charging is suppressed through use of a combination of a polyarylate resin having a specific structure, an electron transporting substance, and a hole transporting substance in an electrophotographic photosensitive member.

According to the investigations made by the inventors, it has been clarified that, although the deterioration of chargeability at the time of long-term repeated use can be suppressed in the electrophotographic photosensitive member as described in Japanese Patent Laid-Open No. 2020-118706, fluctuations in post-exposure potential occur in an electrophotographic apparatus using corona charging.

### SUMMARY

Thus, the present disclosure is directed to the provision of an electrophotographic apparatus including a corona charger and an electrophotographic photosensitive member capable of suppressing fluctuations in post-exposure potential at the time of long-term repeated use.

The above-mentioned provision of an electrophotographic apparatus is achieved by the present disclosure described below. That is, according to the present disclosure, there is provided an electrophotographic apparatus including: an electrophotographic photosensitive member; and a corona charger configured to positively charge the electrophotographic photosensitive member, wherein the electrophotographic photosensitive member includes a monolayer type photosensitive layer, wherein the photosensitive layer contains a charge generating substance, a hole transporting substance, an electron transporting substance, and a binder resin, wherein the binder resin contains a polyester resin having a structural unit represented by the following formula (a) and a structural unit represented by the following formula (1), and wherein 70 mol % or more of the structural unit represented by the following formula (a) in the polyester resin is a structural unit represented by the following formula (2):

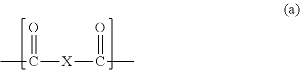

in the formula (a), X represents a divalent organic group free of an ester bond.

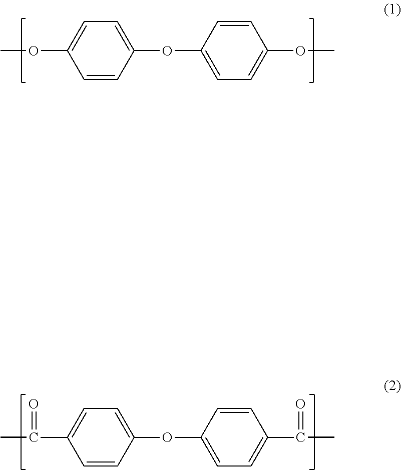

Features of the present disclosure will become apparent from the following description of embodiments with reference to the attached drawings. The following description of embodiments is described by way of example.

### BRIEF DESCRIPTION OF THE DRAWINGS

FIG. 1 is a view for illustrating an example of a layer configuration of an electrophotographic photosensitive member used in the present disclosure.

FIG. 2 is a view for illustrating an example of a layer configuration of an electrophotographic photosensitive member used in the present disclosure.

FIG. 3 is a view for illustrating an example of a schematic configuration of an electrophotographic apparatus according to the present disclosure.

FIG. 4 is a view for illustrating an example of a schematic configuration of an image forming unit included in the electrophotographic apparatus according to the present disclosure.

### DESCRIPTION OF THE EMBODIMENTS

The present disclosure is described below in detail by way of exemplary embodiments.

The inventors have made extensive investigations, and as a result, have found that the above-mentioned problems can be solved by configuring an electrophotographic apparatus as described below.

Specifically, there is provided an electrophotographic apparatus including: an electrophotographic photosensitive member; and a corona charger configured to positively charge the electrophotographic photosensitive member, and the electrophotographic photosensitive member includes a monolayer type photosensitive layer. The photosensitive layer contains a charge generating substance, a hole transporting substance, an electron transporting substance, and a binder resin. In addition, the binder resin contains a polyester resin having a structural unit represented by the following formula (a) and a structural unit represented by the following formula (1). Further, 70 mol % or more of the structural unit represented by the following formula (a) in the polyester resin is a structural unit represented by the following formula (2).

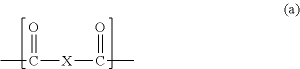

In the formula (a), X represents a divalent organic group free of an ester bond.

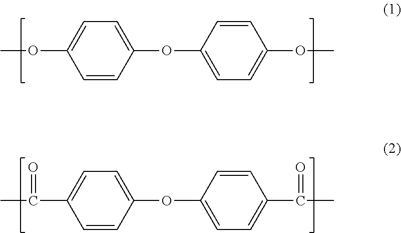

The inventors have conceived the mechanism through which the electrophotographic apparatus having the above-mentioned configuration is effective in achieving both the suppression of deterioration of charging at the time of long-term repeated use and the suppression of fluctuations in post-exposure potential, to be as described below.

First, when the corona charger is used as a charging system, the contamination of a charging member can be suppressed, and hence the photosensitive member can be uniformly charged even at the time of long-term repeated use. However, corona charging generates discharge products, such as ozone, NOx, and ions, and the discharge products cause the deterioration of the photosensitive member. Specifically, there occurs a phenomenon in which the deterioration of the charge generating substance, the electron transporting substance, and the hole transporting substance in the photosensitive layer causes fluctuations in post-charging potential and post-exposure potential.

In Japanese Patent Laid-Open No. 2020-118706, the use of a combination of a polyarylate resin having a specific structure, a hole transporting substance, and an electron transporting substance can prevent the intrusion of a gas component generated by corona charging to suppress a decrease in chargeability. However, the inventors have made investigations, and as a result, have found that, in the electrophotographic photosensitive member as described in Japanese Patent Laid-Open No. 2020-118706, fluctuations in post-exposure potential occur at the time of long-term repeated use in an electrophotographic apparatus using corona charging. The inventors have presumed the reason for the foregoing to be as described below. Positive ions generated by positive corona charging attack the electron transporting substance in the photosensitive layer to cause the deterioration of its ability.

The inventors have made extensive investigations, and as a result, have found that, when the photosensitive layer of the electrophotographic photosensitive member contains the polyester resin having the above-mentioned structural units, fluctuations in post-exposure potential at the time of long-term repeated use can be suppressed.

The structural unit represented by the formula (2) has a structure having a high electron accepting property. In addition, when the structural unit represented by the formula (2) is bonded to the structural unit represented by the formula (1), resonance is stabilized, and the electron accepting property becomes higher. The inventors have presumed that the electrophotographic photosensitive member containing the polyester resin having the structural unit represented by the formula (1) and the structural unit represented by the formula (2) prevents the intrusion of positive ions into the photosensitive layer to prevent the deterioration of the electron transporting substance.

In addition, the above-mentioned polyester resin has a high packing property and a high density because of the presence of a large number of the same ether structures. The inventors have presumed that, because of the foregoing, in particular, a positive ion component can be prevented from attacking the electron transporting substance present in the vicinity of the surface of the photosensitive member, and as a result, fluctuations in post-exposure potential can be suppressed.

The configuration of the electrophotographic photosensitive member included in the electrophotographic apparatus according to the present disclosure is described below in detail.

### [Electrophotographic Photosensitive Member]

The electrophotographic photosensitive member used in the present disclosure is a monolayer type electrophotographic photosensitive member (hereinafter sometimes referred to as “monolayer type photosensitive member”) including at least a support and a monolayer type photosensitive layer formed on the support.

A method of producing the electrophotographic photosensitive member of the present disclosure is, for example, a method including: preparing coating liquids for respective layers to be described later; applying the liquids in a desired order of the layers; and drying the liquids. In this case, examples of the method of applying the coating liquid include dip coating, spray coating, inkjet coating, roll coating, die coating, blade coating, curtain coating, wire bar coating, and ring coating. Of those, dip coating is preferred from the viewpoints of efficiency and productivity.

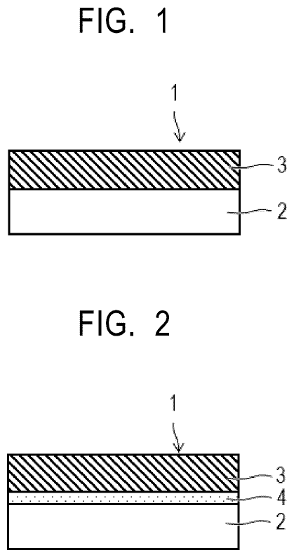

The monolayer type photosensitive member that is the photosensitive member used in the present disclosure is described with reference to FIG. 1 and FIG. 2. FIG. 1 and FIG. 2 are each a partial sectional view for illustrating an example of a layer configuration of the monolayer type photosensitive member.

As illustrated in FIG. 1, a monolayer type photosensitive member 1 includes, for example, an electroconductive support 2 and a photosensitive layer 3. The photosensitive layer 3 included in the monolayer type photosensitive member 1 is a monolayer type photosensitive member that is a monolayer (one layer). The photosensitive layer 3 contains a charge generating substance, a hole transporting substance, an electron transporting substance, and a binder resin.

As illustrated in FIG. 2, the monolayer type photosensitive member 1 may further include an undercoat layer 4 (intermediate layer) in addition to the electroconductive support 2 and the photosensitive layer 3. That is, in the monolayer type photosensitive member 1, the photosensitive layer 3 may be formed directly on the support 2 as illustrated in FIG. 1 or may be formed on the support 2 through intermediation of the undercoat layer 4 as illustrated in FIG. 2.

The thickness of the photosensitive layer 3 is not particularly limited, but is preferably 5 μm or more and 100 μm or less, more preferably 10 μm or more and 50 μm or less.

The support and each layer are described below.

### <Support>

In the present disclosure, the electrophotographic photosensitive member includes a support. In the present disclosure, the support is preferably an electroconductive support having electroconductivity. In addition, examples of the shape of the support include a cylindrical shape, a belt shape, and a sheet shape. A support having a cylindrical shape out of those shapes is preferred. In addition, the surface of the support may be subjected to, for example, electrochemical treatment such as anodization, blast treatment, or cutting treatment.

A metal, a resin, glass, or the like is preferred as a material for the support.

Examples of the metal include aluminum, iron, nickel, copper, gold, stainless steel, and alloys thereof. An aluminum support using aluminum out of those metals is preferred.

In addition, electroconductivity may be imparted to the resin or the glass through treatment involving, for example, mixing or coating the resin or the glass with an electroconductive substance.

### <Undercoat Layer>

In the present disclosure, an undercoat layer may be arranged on the support. The arrangement of the undercoat layer can improve an adhesive function between layers to impart a charge injection inhibiting function.

The undercoat layer preferably contains a resin. In addition, the undercoat layer may be formed as a cured film by polymerizing a composition containing a monomer having a polymerizable functional group.

Examples of the resin include a polyester resin, a polycarbonate resin, a polyvinyl acetal resin, an acrylic resin, an epoxy resin, a melamine resin, a polyurethane resin, a phenol resin, a polyvinyl phenol resin, an alkyd resin, a polyvinyl alcohol resin, a polyethylene oxide resin, a polypropylene oxide resin, a polyamide resin, a polyamic acid resin, a polyimide resin, a polyamide imide resin, and a cellulose resin.

Examples of the polymerizable functional group of the monomer having the polymerizable functional group include an isocyanate group, a blocked isocyanate group, a methylol group, an alkylated methylol group, an epoxy group, a metal alkoxide group, a hydroxyl group, an amino group, a carboxyl group, a thiol group, a carboxylic acid anhydride group, and a carbon-carbon double bond group.

In addition, the undercoat layer may further contain an electron transporting substance, a metal oxide, a metal, an electroconductive polymer, and the like for the purpose of improving electric characteristics. Of those, an electron transporting substance and a metal oxide are preferably used.

Examples of the electron transporting substance include a quinone compound, an imide compound, a benzimidazole compound, a cyclopentadienylidene compound, a fluorenone compound, a xanthone compound, a benzophenone compound, a cyanovinyl compound, a halogenated aryl compound, a silole compound, and a boron-containing compound. An electron transporting substance having a polymerizable functional group may be used as the electron transporting substance and copolymerized with the above-mentioned monomer having a polymerizable functional group to form the undercoat layer as a cured film.

Examples of the metal oxide include indium tin oxide, tin oxide, indium oxide, titanium oxide, zinc oxide, aluminum oxide, and silicon dioxide. Examples of the metal include gold, silver, and aluminum.

In addition, the undercoat layer may further contain an additive.

The thickness of the undercoat layer is preferably 0.1 μm or more and 50 μm or less, more preferably 0.2 μm or more and 40 μm or less, particularly preferably 0.3 μm or more and 30 μm or less.

The undercoat layer may be formed by: preparing a coating liquid for an undercoat layer containing the above-mentioned respective materials and a solvent; forming a coating film of the coating liquid; and drying and/or curing the coating film. Examples of the solvent to be used in the coating liquid include an alcohol-based solvent, a ketone-based solvent, an ether-based solvent, an ester-based solvent, and an aromatic hydrocarbon-based solvent.

### <Monolayer Type Photosensitive Layer>

The electrophotographic photosensitive member used in the present disclosure includes the monolayer type photosensitive layer on the support, or the undercoat layer arranged on the support.

The monolayer type photosensitive layer in the present disclosure is formed so as to contain at least a binder resin, a charge generating substance, a hole transporting substance, and an electron transporting substance.

### [Binder Resin]

The binder resin to be used in the photosensitive layer contains a polyester resin having a structural unit represented by the formula (a) and a structural unit represented by the formula (1), and 70 mol % or more of the structural unit represented by the formula (a) in the polyester resin is a structural unit represented by the formula (2).

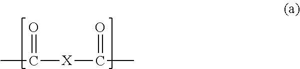

In the formula (a), X represents a divalent organic group free of an ester bond.

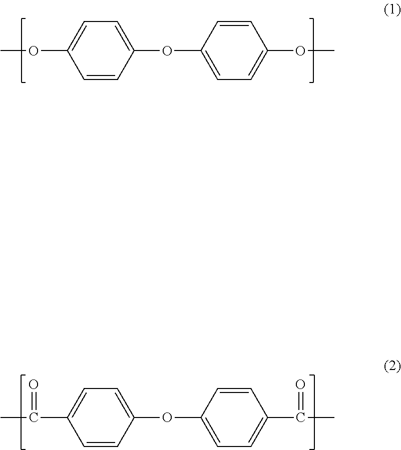

The structural unit represented by the formula (2) is a structure having a high electron accepting property. In addition, when the structural unit represented by the formula (2) is bonded to the structural unit represented by the formula (1), resonance is stabilized, and the electron accepting property becomes higher. It is conceived that the electrophotographic photosensitive member containing the polyester resin having the structural unit represented by the formula (1) and the structural unit represented by the formula (2) prevents the intrusion of positive ions into the photosensitive layer to prevent the deterioration of the electron transporting substance.

The above-mentioned polyester resin may further have a structural unit represented by the following formula (3) in addition to the structural unit represented by the formula (1) and the structural unit represented by the formula (2).

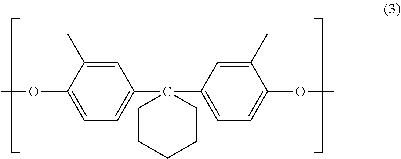

In addition, the above-mentioned polyester resin may further have a structural unit represented by the following formula (4) as the structural unit represented by the formula (a), in addition to the structural unit represented by the formula (1) and the structural unit represented by the formula (2).

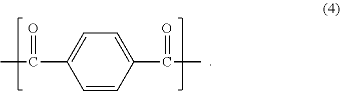

When the above-mentioned polyester resin has the structural unit represented by the formula (3) and the structural unit represented by the formula (4), the solubility of the polyester resin in a solvent is improved, and hence the photosensitive layer can be satisfactorily formed.

The ratio of the substance amount in terms of mole of the structural unit represented by the formula (1) with respect to the total sum of the substance amounts in terms of mole of the structural units for forming the above-mentioned polyester resin is represented by M1 and the ratio of the substance amount in terms of mole of the structural unit represented by the formula (3) with respect to the total sum of substance amounts in terms of mole of the structural units for forming the polyester resin is represented by M3. In this case, it is preferred that the ratio M1/(M1+M3) be larger from the viewpoint of blocking a positive ion component. Meanwhile, it is preferred that the ratio M1/(M1+M3) be 0.50 or less from the viewpoint of solubility in a solvent. That is, it is preferred that the M1 and the M3 satisfy a relationship represented by 0<M1/(M1+M3)≤0.50. The solubility in a solvent is improved, and hence the photosensitive layer can be satisfactorily formed.

In the above-mentioned polyester resin, the sum of the ratio of the substance amount in terms of mole of the structural unit represented by the formula (2) and the ratio of the substance amount in terms of mole of the structural unit represented by the formula (4) is preferably 0.50 or more with respect to the total sum of the substance amounts in terms of mole of structural units derived from dicarboxylic acids for forming the polyester resin.

In the above-mentioned polyester resin, the sum of the ratio of the substance amount in terms of mole of the structural unit represented by the formula (1) and the ratio of the substance amount in terms of mole of the structural unit represented by the formula (3) is preferably more than 0 and 0.50 or less with respect to the total sum of the substance amounts in terms of mole of structural units derived from bisphenols for forming the polyester resin.

The photosensitive layer may contain a resin other than the above-mentioned polyester resin to the extent that the effects of the present disclosure are not impaired. Examples of the other resin include a polycarbonate resin, a styrene resin, and an acrylic resin. The polyester resin may be, for example, a random copolymer, an alternating copolymer, a periodic copolymer, or a block copolymer.

The ratio of the polyester resin having the structural unit represented by the formula (1) and the structural unit represented by the formula (a) is preferably 50 mass % or more with respect to the total mass of the binder resin in the photosensitive layer.

The viscosity-average molecular weight of the above-mentioned polyester resin is preferably 10,000 or more, more preferably 30,000 or more, still more preferably 50,000 or more. When the viscosity-average molecular weight of the above-mentioned polyester resin is 10,000 or more, the wear resistance of the photosensitive member is improved. Meanwhile, the viscosity-average molecular weight of the above-mentioned polyester resin is preferably 80,000 or less, more preferably 70,000 or less. When the viscosity-average molecular weight of the above-mentioned polyester resin is 80,000 or less, the above-mentioned polyester resin is easily dissolved in a solvent for forming a photosensitive layer.

In the present disclosure, the above-mentioned polyester resin is formed so as to have the structural unit represented by the formula (1) as a bisphenol-derived repeating unit and the structural unit represented by the formula (2) as a dicarboxylic acid-derived repeating unit. In addition, in the present disclosure, the above-mentioned polyester resin is preferably formed so as to further have the structural unit represented by the formula (3) as the bisphenol-derived repeating unit and the structural unit represented by the formula (4) as the dicarboxylic acid-derived repeating unit.

Examples of the bisphenol for forming the bisphenol-derived repeating unit include a compound represented by the following formula (BP-1) and a compound represented by the following formula (BP-2). The compound represented by the formula (BP-1) and the compound represented by the formula (BP-2) are hereinafter sometimes referred to as “compound (BP-1)” and “compound (BP-2),” respectively.

Examples of the dicarboxylic acid for forming the dicarboxylic acid-derived repeating unit include a compound represented by the following formula (DC-1) and a compound represented by the following formula (DC-2). The compound represented by the formula (DC-1) and the compound represented by the formula (DC-2) are hereinafter sometimes referred to as “compound (DC-1)” and “compound (DC-2),” respectively.

The amounts of the compound (BP-1) and the compound (BP-2) to be added at the time of the production of the above-mentioned polyester resin are appropriately changed. Thus, a bisphenol ratio in the above-mentioned polyester resin (that is, the content ratios of the structural unit represented by the formula (1) and the structural unit represented by the formula (3)) may be adjusted. In addition, similarly, for the amount of the dicarboxylic acids, the amounts of the compound (DC-1) and the compound (DC-2) to be added at the time of the production the above-mentioned polyester resin may be appropriately changed. Thus, a dicarboxylic acid ratio in the above-mentioned polyester resin (that is, the content ratios of the structural unit represented by the formula (2) and the structural unit represented by the formula (4)) may be adjusted.

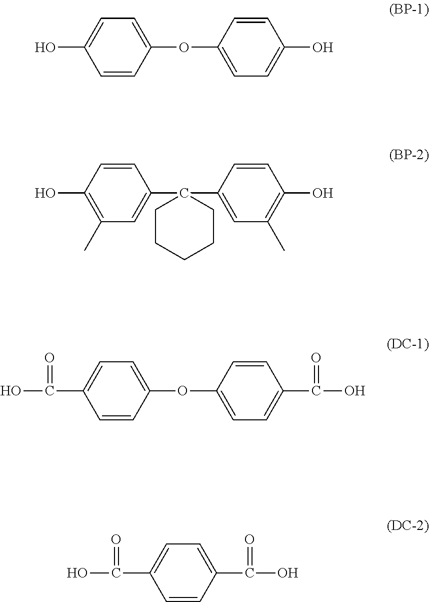

The bisphenols (e.g., the compound (BP-1) and the compound (BP-2)) may each be used by being derivatized into an aromatic diacetate. The dicarboxylic acids (e.g., the compound (DC-1) and the compound (DC-2)) may each be used by being derivatized. Examples of the derivative of the dicarboxylic acid include a dicarboxylic acid dichloride, a dicarboxylic acid dimethyl ester, a dicarboxylic acid diethyl ester, and a dicarboxylic acid anhydride. The dicarboxylic acid dichloride is a compound having a structure obtained by substituting each of two “—C(═O)—OH” groups of the dicarboxylic acid with a “—C(═O)—Cl” group.

In the polycondensation of the bisphenol and the dicarboxylic acid, one or both of a base and a catalyst may be added. An example of the base is sodium hydroxide. Examples of the catalyst include benzyltributylammonium chloride, ammonium chloride, ammonium bromide, a quaternary ammonium salt, triethylamine, and trimethylamine.

The photosensitive layer may contain, as the binder resin, only the polyester resin having the structural unit represented by the formula (2) and the structural unit represented by the formula (1) or may further contain a binder resin other than the polyester resin. The polyester resin having the structural unit represented by the formula (2) and the structural unit represented by the formula (1) may be referred to as “other binder resin in the photosensitive layer.”

Examples of the other binder resin in the photosensitive layer include thermoplastic resins, thermosetting resins, and photocurable resins. Specific examples of the thermoplastic resins include a polyester resin other than the above-mentioned polyester resin, a polycarbonate resin, a styrene-based resin, a styrene-butadiene copolymer, a styrene-acrylonitrile copolymer, a styrene-maleic acid copolymer, a styrene-acrylic acid copolymer, an acrylic copolymer, a polyethylene resin, an ethylene-vinyl acetate copolymer, a chlorinated polyethylene resin, a polyvinyl chloride resin, a polypropylene resin, an ionomer, a vinyl chloride-vinyl acetate copolymer, a polyester resin, an alkyd resin, a polyamide resin, a polyurethane resin, a polysulfone resin, a diallyl phthalate resin, a ketone resin, a polyvinyl butyral resin, a polyvinyl acetal resin, and a polyether resin. Specific examples of the thermosetting resins include a silicone resin, an epoxy resin, a phenol resin, a urea resin, a melamine resin, and any other crosslinkable thermosetting resin. Specific examples of the photocurable resins include an epoxy-acrylic acid-based resin and a urethane-acrylic acid-based copolymer.

The structure of the polyester resin used in the present disclosure may be determined by a ¹H-nuclear magnetic resonance spectrum obtained by performing component analysis of polymer components recovered from the photosensitive layer through use of ¹H-nuclear magnetic resonance spectrometry in deuterated chloroform.

A specific analysis method for the above-mentioned polyester resin in the photosensitive layer when the photosensitive member is a cylindrical body is described below.

### (Reprecipitation of Resin in Photosensitive Layer)

The photosensitive member is cut at a position 10 cm distant from an end portion of the photosensitive member in a generating line direction with a scroll saw.
An inner surface of the cut cylindrical body of 10 cm is wiped with lens-cleaning paper impregnated with chloroform.
To elute the photosensitive layer, 3 cm of an end portion of the cut cylindrical body is immersed in chloroform. (About 60 ml of chloroform is loaded into a 100 ml beaker, and the end portion is immersed therein at normal temperature for 5 minutes.)
The chloroform solution in which the above-mentioned photosensitive layer has been eluted is concentrated to 2 mL with a rotary evaporator, and the concentration is stopped.
50 Milliliters of a methanol/acetone mixed solution (volume ratio: 1:1) is prepared, and while the mixed solution is stirred, the whole amount of the above-mentioned concentrated solution is dropped thereinto to perform reprecipitation.
Suction filtration is performed with a funnel (funnel: SU-40, paper filter: No. 5C-40, manufactured by Kiriyama Glass Co.).
The residue on the paper filter is recovered with a spatula and dried in a vacuum (70° C., 1 hour).

### (NMR Measurement)

To prepare a measurement sample, 20 mg of a sample is dissolved in 1 g of deuterated chloroform containing tetramethylsilane serving as a reference material, and the whole amount thereof is transferred to an NMR tube (deuterated chloroform: manufactured by Sigma-Aldrich Japan G.K., chloroform-d, model number: 612200) (NMR tube: manufactured by Norell, Inc., ST500-7, model number: S3010).
NMR measurement is performed.
   Apparatus: AVANCE 500 manufactured by Bruker
   Conditions: Proton NMR, automatic measurement by Icon-NMR
   Number of scans: 32
   Reference peak: The peak of a methyl group of tetramethylsilane is set as 0 ppm.

### [Charge Generating Substance]

Examples of the charge generating substance include a phthalocyanine-based pigment, a perylene-based pigment, a bisazo pigment, a trisazo pigment, a dithioketopyrrolopyrrole pigment, a metal-free naphthalocyanine pigment, a metal naphthalocyanine pigment, a squaraine pigment, an indigo pigment, an azulenium pigment, a cyanine pigment, powder of an inorganic photoconductive substance (e.g., selenium, selenium-tellurium, selenium-arsenic, cadmium sulfide, and amorphous silicon), a pyrylium pigment, an anthanthrone-based pigment, a triphenylmethane-based pigment, a threne-based pigment, a toluidine-based pigment, a pyrazoline-based pigment, and a quinacridone-based pigment. The photosensitive layer may contain only one kind of charge generating substance, or may contain two or more kinds of charge generating substances.

The phthalocyanine-based pigment is a pigment having a phthalocyanine structure. Examples of the phthalocyanine-based pigment include metal-free phthalocyanine and a metal phthalocyanine. Examples of the metal phthalocyanine include titanyl phthalocyanine, hydroxygallium phthalocyanine, and chlorogallium phthalocyanine. The metal phthalocyanine is preferably titanyl phthalocyanine. Titanyl phthalocyanine is a compound represented by the following formula (CGM-1), and metal-free phthalocyanine is a compound represented by the following formula (CGM-2).

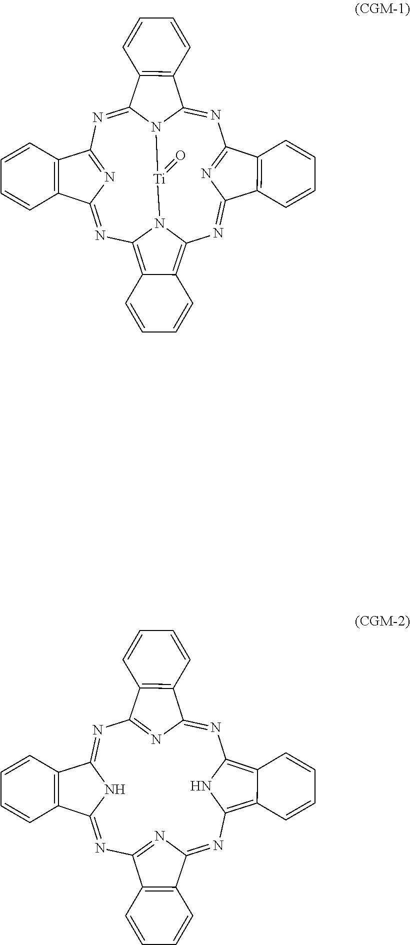

The phthalocyanine-based pigment may be crystalline or amorphous. An example of the crystal of metal-free phthalocyanine is an X-form crystal of metal-free phthalocyanine (hereinafter sometimes referred to as “X-form metal-free phthalocyanine”). Examples of the crystal of titanyl phthalocyanine include an α-form crystal, a β-form crystal, and a Y-form crystal of titanyl phthalocyanine (hereinafter sometimes referred to as “α-form titanyl phthalocyanine,” “β-form titanyl phthalocyanine,” and “Y-form titanyl phthalocyanine,” respectively). For example, in a digital optical electrophotographic apparatus (e.g., a laser beam printer or a facsimile using a light source such as a semiconductor laser), a photosensitive member having sensitivity in a wavelength region of 700 nm or more is preferably used. The charge generating substance is preferably a phthalocyanine-based pigment, more preferably metal-free phthalocyanine or titanyl phthalocyanine because these substances each have a high quantum yield in a wavelength region of 700 nm or more. In addition, the charge generating substance is still more preferably titanyl phthalocyanine, particularly preferably Y-form titanyl phthalocyanine.

The Y-form titanyl phthalocyanine has a main peak, for example, at a Bragg angle (2θ±0.2°) of 27.2° in a CuKα characteristic X-ray diffraction spectrum. The main peak in the CuKα characteristic X-ray diffraction spectrum is a peak having the first or second largest intensity in the range of a Bragg angle (2θ±0.2°) of 3° or more and 40° or less. The Y-form titanyl phthalocyanine does not have a peak at 26.2° in the CuKα characteristic X-ray diffraction spectrum.

The CuKα characteristic X-ray diffraction spectrum may be measured, for example, by the following method. First, a sample (titanyl phthalocyanine) is loaded into a sample holder of an X-ray diffraction apparatus (e.g., “RINT (trademark) 1100” manufactured by Rigaku Corporation). Subsequently, an X-ray diffraction spectrum is measured under the conditions of an X-ray tube bulb of Cu, a tube voltage of 40 kV, a tube current of 30 mA, and a CuKα characteristic X-ray wavelength of 1.542 Å. A measurement range (2θ) is, for example, 3° or more and 40° or less (start angle: 3° and stop angle: 40°), and a scanning speed is, for example, 10°/min. The main peak is determined from the resultant X-ray diffraction spectrum, and the Bragg angle of the main peak is read.

The content of the charge generating substance in the photosensitive layer is preferably 0.1 part by mass or more and 50 parts by mass or less, more preferably 0.5 part by mass or more and 5 parts by mass or less with respect to 100 parts by mass of the binder resin.

### [Electron Transporting Substance]

The electron transporting substance may contain at least one selected from the group consisting of: a compound represented by the following formula (10); a compound represented by the following formula (11); a compound represented by the following formula (12); a compound represented by the following formula (13); a compound represented by the following formula (14); a compound represented by the following formula (15); and a compound represented by the following formula (16). It is conceived that, when the photosensitive layer contains the above-mentioned electron transporting substance, the compatibility between the binder resin and a hole transporting substance to be described later in the present disclosure is increased to increase the homogencity of the inside of the photosensitive layer, and hence the enhanced effects of the present disclosure are obtained.

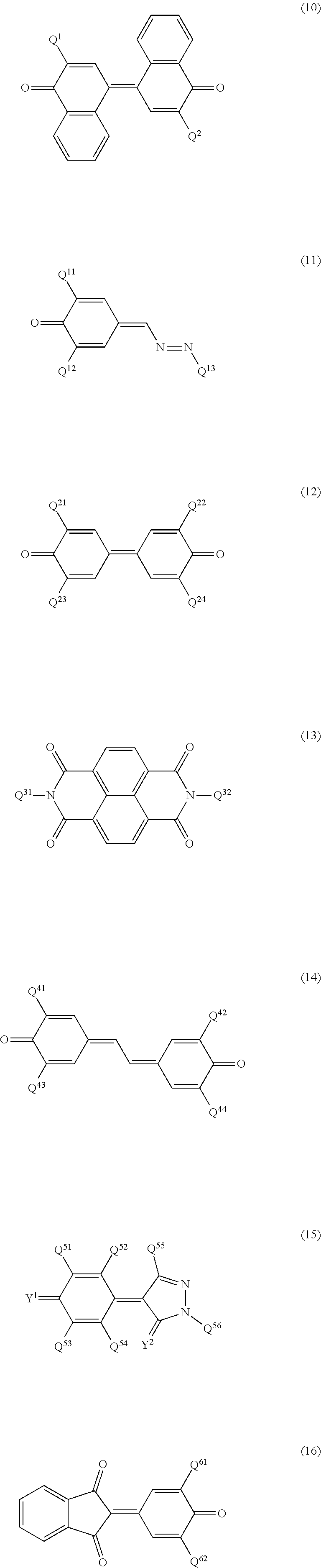

Q¹ and Q² in the formula (10), Q¹¹, Q¹², and Q¹³ in the formula (11), Q²¹, Q²², Q²³, and Q²⁴ in the formula (12), Q³¹ and Q³² in the formula (13), Q⁴¹, Q⁴², Q⁴³, and Q⁴⁴ in the formula (14), Q⁵¹, Q⁵², Q⁵³, Q⁵⁴, Q⁵⁵, and Q⁵⁶ in the formula (15), and Q⁶¹ and Q⁶² in the formula (16) each independently represent a hydrogen atom, a halogen atom, a cyano group, an alkyl group having 1 or more and 6 or less carbon atoms, an alkenyl group having 2 or more and 6 or less carbon atoms, an alkoxy group having 1 or more and 6 or less carbon atoms, or an aryl group having 6 or more and 14 or less carbon atoms that may be substituted with at least one substituent selected from the group consisting of: an alkyl group having 1 or more and 6 or less carbon atoms; and a halogen atom. Y¹ and Y² in the formula (15) each independently represent an oxygen atom or a sulfur atom.

It is preferred that Q¹ and Q² in the formula (10), Q¹¹ to Q¹³ in the formula (11), Q²¹ to Q²⁴ in the formula (12), Q³¹ and Q³² in the formula (13), Q⁴¹ to Q⁴⁴ in the formula (14), Q⁵¹ to Q⁵⁶ in the formula (15), and Q⁶¹ and Q⁶² in the formula (16) each independently represent a hydrogen atom, an alkyl group having 1 or more and 6 or less carbon atoms, or an aryl group having 6 or more and 14 or less carbon atoms that may be substituted with at least one substituent selected from the group consisting of: an alkyl group having 1 or more and 6 or less carbon atoms; and a halogen atom. It is preferred that Y¹ and Y² in the formula (15) each represent an oxygen atom.

When Q¹ and Q² in the formula (10), Q¹¹ to Q¹³ in the formula (11), Q²¹ to Q²⁴ in the formula (12), Q³¹ and Q³² in the formula (13), Q⁴¹ to Q⁴⁴ in the formula (14), Q⁵¹ to Q⁵⁶ in the formula (15), and Q⁶¹ and Q⁶² in the formula (16) each represent an alkyl group having 1 or more and 6 or less carbon atoms, these groups each represent preferably an alkyl group having 1 or more and 5 or less carbon atoms, preferably a methyl group, an ethyl group, a propyl group, a butyl group, or a pentyl group, particularly preferably a methyl group, an isopropyl group, a tert-butyl group, or a 1,1-dimethylpropyl group.

When Q¹ and Q² in the formula (10), Q¹¹ to Q¹³ in the formula (11), Q²¹ to Q²⁴ in the formula (12), Q³¹ and Q³² in the formula (13), Q⁴¹ to Q⁴⁴ in the formula (14), Q⁵¹ to Q⁵⁶ in the formula (15), and Q⁶¹ and Q⁶² in the formula (16) each represent an aryl group having 6 or more and 14 or less carbon atoms, these groups each represent preferably an aryl group having 6 or more and 10 or less carbon atoms, more preferably a phenyl group.

Here, the alkyl group having 1 or more and 6 or less carbon atoms that the aryl group having 6 or more and 14 or less carbon atoms may have as a substituent is preferably an alkyl group having 1 or more and 3 or less carbon atoms, more preferably a methyl group or an ethyl group.

In addition, the halogen atom that the aryl group having 6 or more and 14 or less carbon atoms may have as a substituent is preferably a fluorine atom, a chlorine atom, or a bromine atom, particularly preferably a chlorine atom.

When the aryl group having 6 or more and 14 or less carbon atoms is substituted with a substituent, the number of substituents is preferably 1 or more and 5 or less, more preferably 1 or 2.

The aryl group having 6 or more and 14 or less carbon atoms that is substituted with at least one substituent selected from the group consisting of: an alkyl group having 1 or more and 6 or less carbon atoms; and a halogen atom is preferably a chlorophenyl group, a dichlorophenyl group, or an ethylmethylphenyl group, more preferably a 4-chlorophenyl group, a 2,5-dichlorophenyl group, or a 2-ethyl-6-methylphenyl group.

A suitable example of the compound represented by the formula (10) is a compound represented by the following formula (E-4). A suitable example of the compound represented by the formula (11) is a compound represented by the following formula (E-5). A suitable example of the compound represented by the formula (12) is a compound represented by the following formula (E-7). A suitable example of the compound represented by the formula (13) is a compound represented by the following formula (E-6). A suitable example of the compound represented by the formula (14) is a compound represented by the following formula (E-8). Suitable examples of the compound represented by the formula (15) include a compound represented by the following formula (E-2) and a compound represented by the following formula (E-3). A suitable example of the compound represented by the formula (16) is a compound represented by the following formula (E-1). The compounds represented by the following formulae (E-1) to (E-8), respectively, are sometimes referred to as “electron transporting substance (E-1) to electron transporting substance (E-8),” respectively.

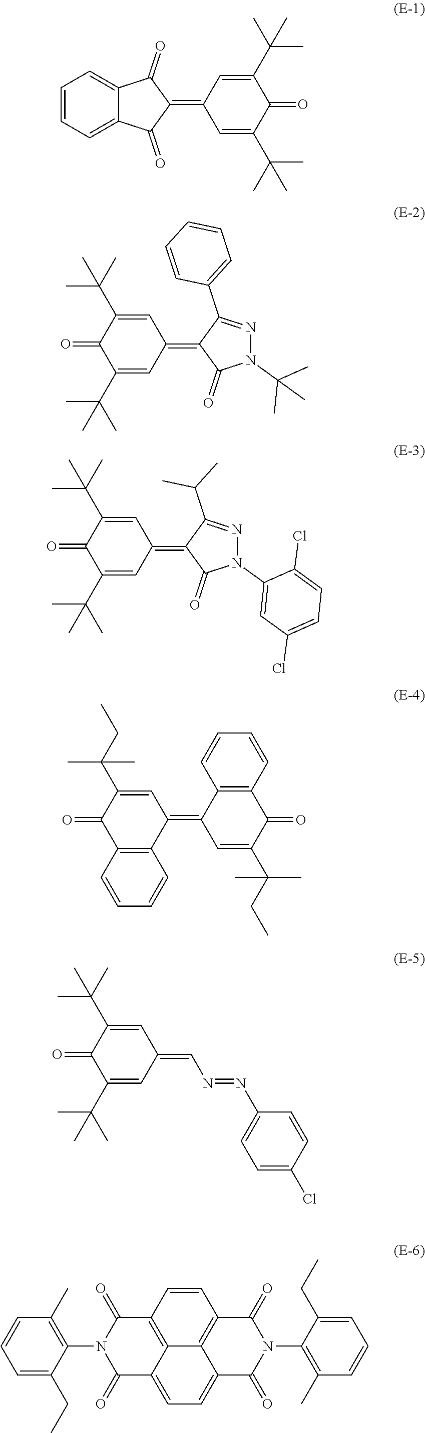

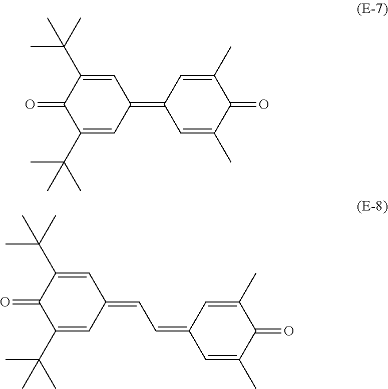

The content of the electron transporting substance in the photosensitive layer is preferably 5 parts by mass or more and 150 parts by mass or less, more preferably 10 parts by mass or more and 100 parts by mass or less, still more preferably 30 parts by mass or more and 70 parts by mass or less with respect to 100 parts by mass of the binder resin. The photosensitive layer may contain only one kind of electron transporting substance, or may contain two or more kinds of electron transporting substances.

### [Hole Transporting Substance]

The hole transporting substance preferably contains at least one selected from the group consisting of: a compound represented by the following formula (20); a compound represented by the following formula (21); a compound represented by the following formula (22); a compound represented by the following formula (23); and a compound represented by the following formula (24). It is conceived that, when the photosensitive layer contains the above-mentioned hole transporting substance, the compatibility between the above-mentioned polyester resin and the electron transporting substance is increased to increase the homogeneity of the inside of the photosensitive layer, and hence the enhanced effects of the present disclosure are obtained.

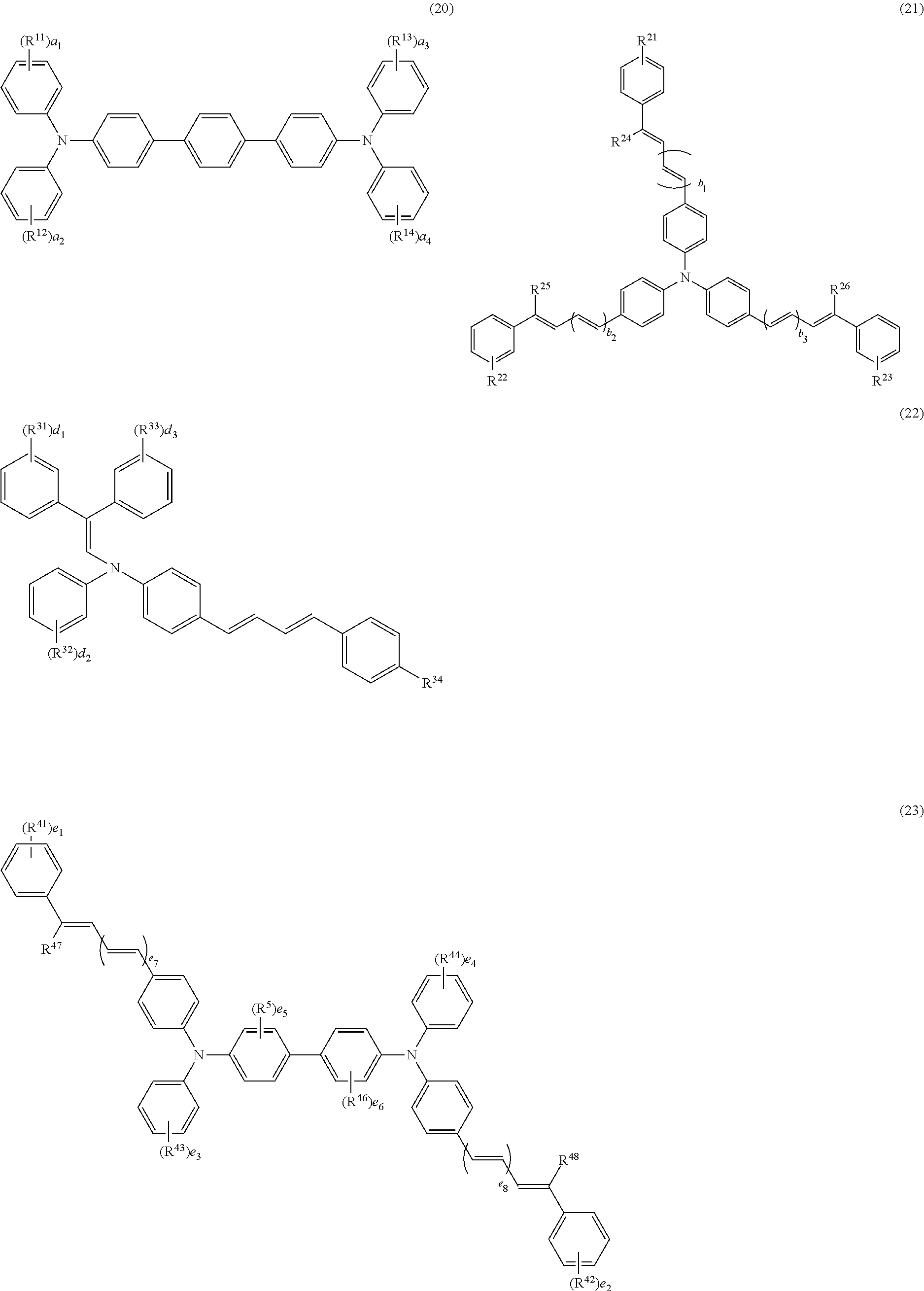

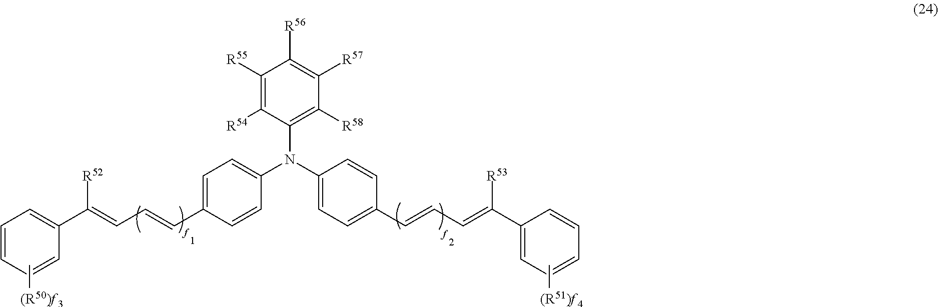

In the formula (20), R¹¹, R¹², R¹³, and R¹⁴ each independently represent an alkyl group having 1 or more and 6 or less carbon atoms, or an alkoxy group having 1 or more and 6 or less carbon atoms, and a₁, a₂, a₃, and a₄ each independently represent an integer of 0 or more and 5 or less. In the formula (21), R²¹, R²², and R²³ each independently represent an alkyl group having 1 or more and 6 or less carbon atoms, R²⁴, R²⁵, and R²⁶ each independently represent a hydrogen atom, or an alkyl group having 1 or more and 6 or less carbon atoms, and b₁, b₂, and b₃ each independently represent 0 or 1. In the formula (22), R³¹, R³², and R³³ each independently represent an alkyl group having 1 or more and 6 or less carbon atoms, R³⁴ represents an alkyl group having 1 or more and 6 or less carbon atoms, or a hydrogen atom, and d₁, d₂, and d₃ each independently represent an integer of 0 or more and 5 or less. In the formula (23), R⁴¹, R⁴², R⁴³, R⁴⁴, R⁴⁵, and R⁴⁶ each independently represent an alkyl group having 1 or more and 6 or less carbon atoms, or a phenyl group, R⁴⁷ and R⁴⁸ each independently represent a hydrogen atom, an alkyl group having 1 or more and 6 or less carbon atoms, or a phenyl group, e₁, e₂, e₃, and e₄ each independently represent an integer of 0 or more and 5 or less, e₅ and e₆ each independently represent an integer of 0 or more and 4 or less, and e₇ and e₈ each independently represent 0 or 1. In the formula (24), R⁵⁰ and R⁵¹ each independently represent an alkyl group having 1 or more and 6 or less carbon atoms, an alkoxy group having 1 or more and 6 or less carbon atoms, or a phenyl group, R⁵², R⁵³, R⁵⁴, R⁵⁵, R⁵⁶, R⁵⁷, and R⁵⁸ each independently represent a hydrogen atom, an alkyl group having 1 or more and 6 or less carbon atoms, an alkoxy group having 1 or more and 6 or less carbon atoms, or a phenyl group that may be substituted with an alkyl group having 1 or more and 6 or less carbon atoms, f₁ and f₂ each independently represent an integer of 0 or more and 2 or less, and f₃ and f₄ each independently represent an integer of 0 or more and 5 or less.

In the formula (20), when a₁ represents an integer of 2 or more and 5 or less, a plurality of R¹¹s may represent groups identical to or different from each other. When a₂ represents an integer of 2 or more and 5 or less, a plurality of R¹²s may represent groups identical to or different from each other. When a₃ represents an integer of 2 or more and 5 or less, a plurality of R¹³s may represent groups identical to or different from each other. When a₄ represents an integer of 2 or more and 5 or less, a plurality of R¹⁴s may represent groups identical to or different from each other. In the formula (20), R¹¹, R¹², R¹³, and R¹⁴ each independently represent preferably an alkyl group having 1 or more and 3 or less carbon atoms, more preferably a methyl group or an ethyl group. a₁, a₂, a₃, and a₄ each independently represent preferably an integer of 1 or more and 3 or less, more preferably 1.

In the formula (21), R²¹, R²², and R²³ each independently represent preferably an alkyl group having 1 or more and 3 or less carbon atoms, more preferably a methyl group. The bonding position of each of R²¹, R²², and R²³ in a phenyl group is preferably a meta-position with respect to the bonding position of the phenyl group to a triphenylamine structure. R²⁴, R²⁵, and R²⁶ each preferably represent a hydrogen atom. It is preferred that b₁, b₂, and b₃ all represent 0 or all represent 1.

In the formula (22), when d₁ represents an integer of 2 or more and 5 or less, a plurality of R³¹s may represent groups identical to or different from each other. When d₂ represents an integer of 2 or more and 5 or less, a plurality of R³²s may represent groups identical to or different from each other. When d₃ represents an integer of 2 or more and 5 or less, a plurality of R³³s may represent groups identical to or different from each other. In the formula (22), R³⁴ preferably represents a hydrogen atom. d₁, d₂, and d₃ each preferably represent 0.

In the formula (23), when e represents an integer of 2 or more and 5 or less, a plurality of R⁴¹s may represent groups identical to or different from each other. When e₂ represents an integer of 2 or more and 5 or less, a plurality of R⁴²s may represent groups identical to or different from each other. When e₃ represents an integer of 2 or more and 5 or less, a plurality of R⁴³s may represent groups identical to or different from each other. When e₄ represents an integer of 2 or more and 5 or less, a plurality of R⁴⁴s may represent groups identical to or different from each other. When e₅ represents an integer of 2 or more and 4 or less, a plurality of R⁴⁵s may represent groups identical to or different from each other. When e₆ represents an integer of 2 or more and 4 or less, a plurality of R⁴⁶s may represent groups identical to or different from each other. In the formula (23), R⁴¹ to R⁴⁶ each independently represent preferably an alkyl group having 1 or more and 6 or less carbon atoms, more preferably an alkyl group having 1 or more and 3 or less carbon atoms, still more preferably a methyl group or an ethyl group. R⁴⁷ and R⁴⁸ each preferably represent a hydrogen atom. It is preferred that e₁, e₂, e₃, and e₄ each independently represent an integer of 0 or more and 2 or less. It is more preferred that e₁ and e₂ each represent 0, and e₃ and e₄ each represent 2. e₅ and e₆ each preferably represent 0. It is preferred that e₇ and e₈ all represent 0 or all represent 1.

In the formula (24), when f₃ represents an integer of 2 or more and 5 or less, a plurality of R⁵⁰s may represent groups identical to or different from each other. When f₄ represents an integer of 2 or more and 5 or less, a plurality of R⁵¹s may represent groups identical to or different from each other. In the formula (24), it is preferred that R⁵⁰ and R⁵¹ each independently represent an alkyl group having 1 or more and 6 or less carbon atoms. It is preferred that R⁵² and R⁵³ each represent a hydrogen atom, or a phenyl group that may be substituted with an alkyl group having 1 or more and 6 or less carbon atoms. It is preferred that R⁵⁴ to R⁵⁸ each independently represent a hydrogen atom, an alkyl group having 1 or more and 6 or less carbon atoms, or an alkoxy group having 1 or more and 6 or less carbon atoms. It is preferred that f₁ and f₂ all represent 0, all represent 1, or all represent 2. It is preferred that f₃ and f₄ each independently represent 0 or 1. When R⁵⁰ and R⁵¹ each represent an alkyl group having 1 or more and 6 or less carbon atoms, these groups each represent preferably an alkyl group having 1 or more and 3 or less carbon atoms, more preferably a methyl group. When R⁵² and R⁵³ each represent a phenyl group that may be substituted with an alkyl group having 1 or more and 6 or less carbon atoms, these groups each preferably represent a phenyl group, or a phenyl group that is substituted with an alkyl group having 1 or more and 3 or less carbon atoms. The phenyl group that is substituted with an alkyl group having 1 or more and 3 or less carbon atoms is preferably a methylphenyl group, more preferably a 4-methylphenyl group. When R⁵⁴ to R⁵⁸ each represent an alkyl group having 1 or more and 6 or less carbon atoms, these groups each represent preferably an alkyl group having 1 or more and 4 or less carbon atoms, more preferably a methyl group, an ethyl group, or a n-butyl group. When R⁵⁴ to R⁵⁸ each represent an alkoxy group having 1 or more and 6 or less carbon atoms, these groups each represent preferably an alkoxy group having 1 or more and 3 or less carbon atoms, more preferably an ethoxy group.

A suitable example of the compound represented by the formula (20) is a compound represented by the following formula (H-11). Suitable examples of the compound represented by the formula (21) include a compound represented by the following formula (H-7) and a compound represented by the following formula (H-8). A suitable example of the compound represented by the formula (22) is a compound represented by the following formula (H-6). Suitable examples of the compound represented by the formula (23) include a compound represented by the following formula (H-9) and a compound represented by the following formula (H-10). Suitable examples of the compound represented by the formula (24) include a compound represented by the following formula (H-1), a compound represented by the following formula (H-2), a compound represented by the following formula (H-3), a compound represented by the following formula (H-4), and a compound represented by the following formula (H-5). The compounds represented by the formulae (H-1) to (H-11) are hereinafter sometimes referred to as “hole transporting substance (H-1) to hole transporting substance (H-11),” respectively.

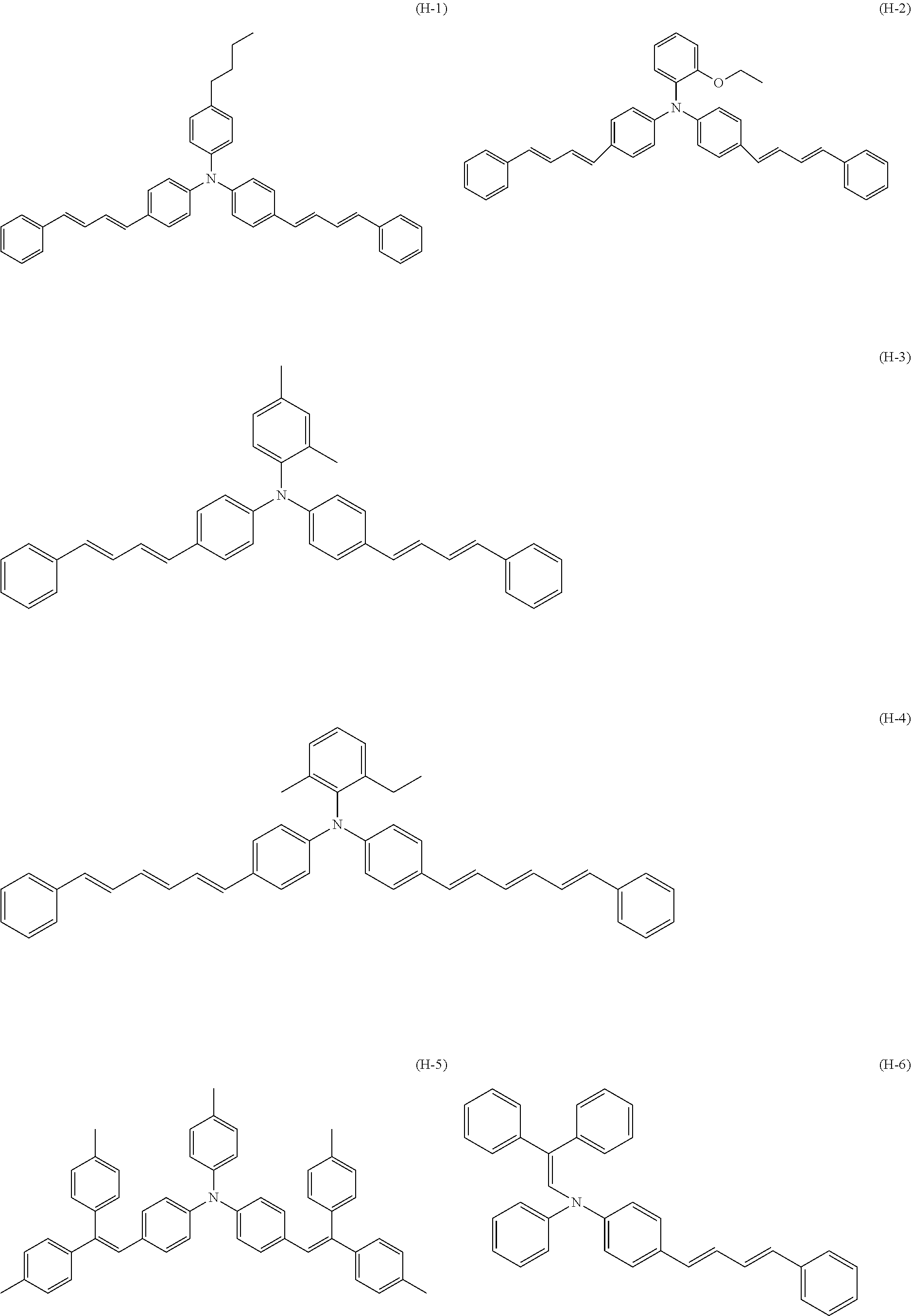

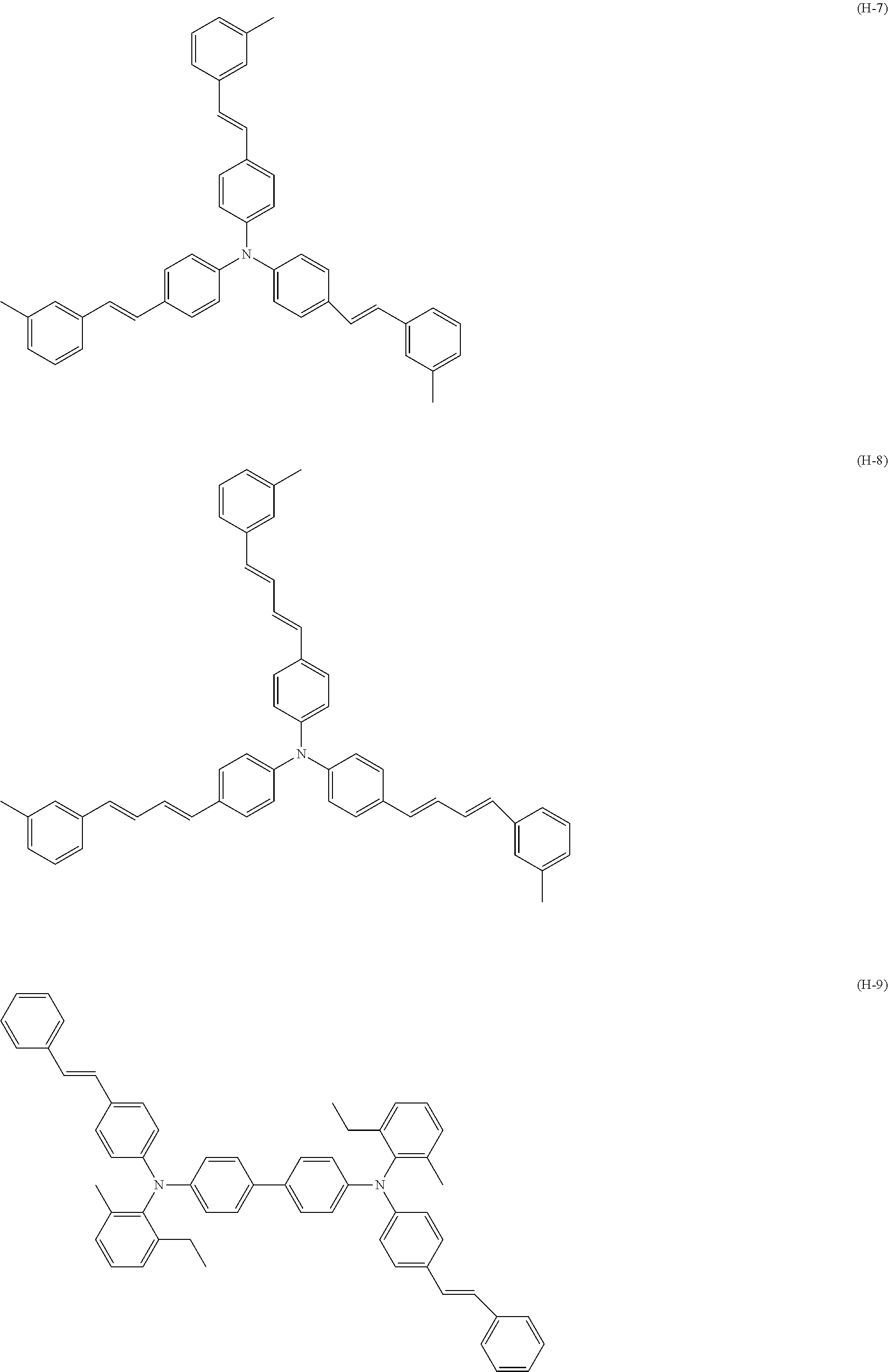 [SMILES: Cc1cccc(/C=C/c2ccc(N(c3ccc(/C=C/c4cccc(C)c4)cc3)c3ccc(/C=C/c4cccc(C)c4)cc3)cc2)c1 ; Cc1cccc(/C=C/C=C/c2ccc(N(c3ccc(/C=C/C=C/c4cccc(C)c4)cc3)c3ccc(/C=C/C=C/c4cccc(C)c4)cc3)cc2)c1 ; CCc1cccc(C)c1N(c1ccc(/C=C/c2ccccc2)cc1)c1ccc(-c2ccc(N(c3ccc(/C=C/c4ccccc4)cc3)c3c(C)cccc3CC)cc2)cc1]

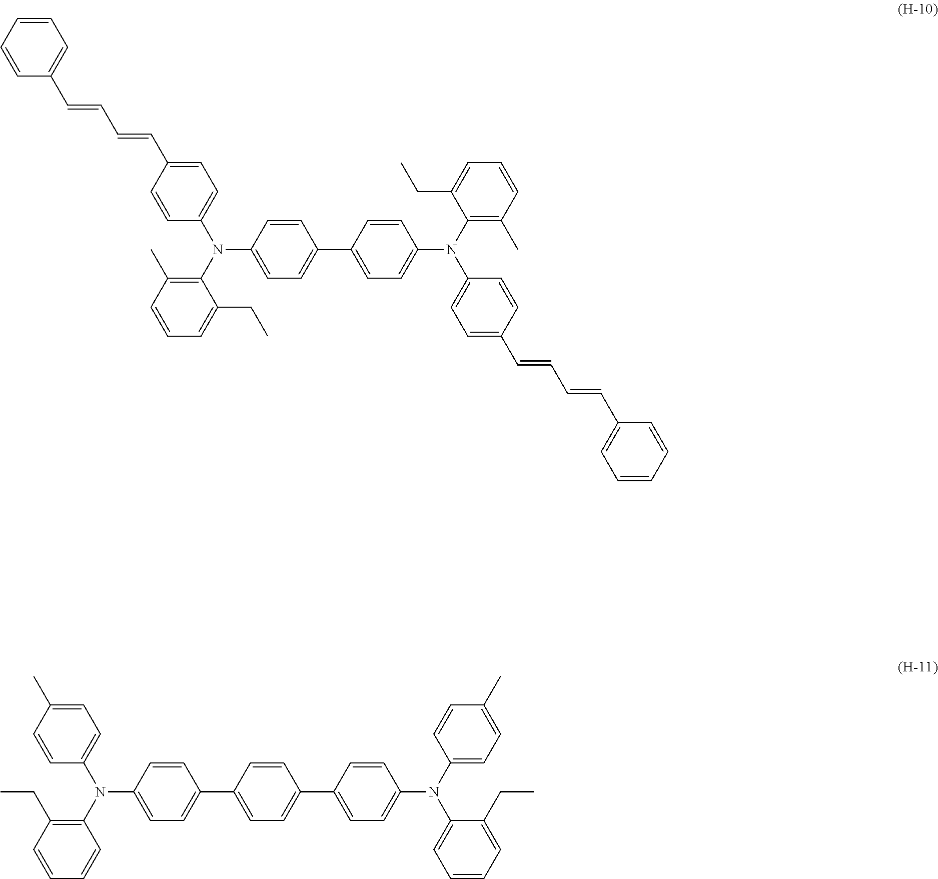 [SMILES: CCc1cccc(C)c1N(c1ccc(/C=C/C=C/c2ccccc2)cc1)c1ccc(-c2ccc(N(c3ccc(/C=C/C=C/c4ccccc4)cc3)c3c(C)cccc3CC)cc2)cc1 ; CCc1ccccc1N(c1ccc(C)cc1)c1ccc(-c2ccc(-c3ccc(N(c4ccc(C)cc4)c4ccccc4CC)cc3)cc2)cc1]

The content of the hole transporting substance in the photosensitive layer is preferably 10 parts by mass or more and 200 parts by mass or less, more preferably 30 parts by mass or more and 120 parts by mass or less, still more preferably 50 parts by mass or more and 90 parts by mass or less with respect to 100 parts by mass of the binder resin.

The photosensitive layer may contain only one kind of hole transporting substance, or may contain two or more kinds of hole transporting substances. In addition, the photosensitive layer may further contain a hole transporting substance other than the compound represented by the formula (20), (21), (22), (23), or (24) (hereinafter sometimes referred to as “other hole transporting substance”). Examples of the other hole transporting substance include triphenylamine derivatives, diamine derivatives (e.g., N,N,N′,N′-tetraphenylbenzidine derivatives, N,N,N′,N′-tetraphenylphenylenediamine derivatives, N,N,N′,N′-tetraphenylnaphthylenediamine derivatives, N,N,N′,N′-tetraphenylphenanthrylenediamine derivatives, and di(aminophenylethenyl)benzene derivatives), oxadiazole-based compounds (e.g., 2,5-di(4-methylaminophenyl)-1,3,4-oxadiazole), styryl-based compounds (e.g., 9-(4-diethylaminostyryl) anthracene), carbazole-based compounds (e.g., polyvinylcarbazole), organic polysilane compounds, pyrazoline-based compounds (e.g., 1-phenyl-3-(p-dimethylaminophenyl) pyrazoline), hydrazone-based compounds, indole-based compounds, oxazole-based compounds, isoxazole-based compounds, thiazole-based compounds, thiadiazole-based compounds, imidazole-based compounds, pyrazole-based compounds, and triazole-based compounds.

### [Additive]

The photosensitive layer may contain an additive as required. Examples of the additive include a UV absorber, an antioxidant, a radical scavenger, a singlet quencher, a softener, a surface modifier, an extender, a thickener, a wax, a donor, a surfactant, a plasticizer, a sensitizer, and a leveling agent. In particular, it is preferred that the photosensitive layer contain, as an additive, a compound represented by the following formula (T-1).

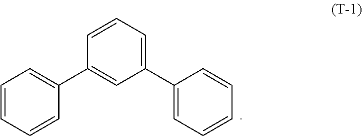 [SMILES: c1ccc(-c2cccc(-c3ccccc3)c2)cc1]

### (Vickers Hardness)

The Vickers hardness of the photosensitive layer is preferably 18.0 HV or more, more preferably 19.0 HV or more. When the Vickers hardness of the photosensitive layer is 19.0 HV or more, the film uniformity of the photosensitive member is improved, and hence a reducing effect on pressure non-uniformity is increased. The upper limit of the Vickers hardness of the photosensitive layer is not particularly limited, and for example, the Vickers hardness of the photosensitive layer is 25.0 HV or less. When the Vickers hardness of the photosensitive layer is too large, the pressure non-uniformity may be rather increased. The Vickers hardness of the photosensitive layer is measured by a method in conformity with Japanese Industrial Standards (JIS) Z2244. The Vickers hardness of the photosensitive layer is adjusted, for example, by changing the kinds of the binder resin, the hole transporting substance, and the electron transporting substance.

### [Electrophotographic Apparatus]

The electrophotographic apparatus according to the present disclosure includes the electrophotographic photosensitive member described above, a charging unit, an exposing unit, a developing unit, and a transfer unit. The charging unit charges the surface of the electrophotographic photosensitive member. In addition, the exposing unit irradiates the charged surface of the photosensitive member with light to form an electrostatic latent image on the surface of the photosensitive member. In addition, the developing unit includes toner, and develops the electrostatic latent image formed on the surface of the photosensitive member with the toner, to form a toner image on the surface of the photosensitive member.

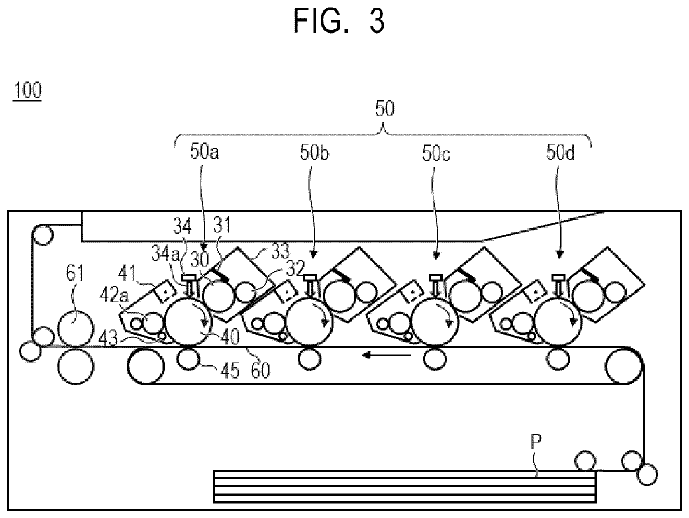

A tandem-type color electrophotographic apparatus illustrated in FIG. 3 is described as an example.

An electrophotographic apparatus 100 illustrated in FIG. 3 includes image forming units 50a, 50b, 50c, and 50d, a transfer belt 60, and a fixing device 61. When distinction is not required, each of the image forming units 50a, 50b, 50c, and 50d is hereinafter described as an image forming unit 50.

The image forming unit 50 includes an image bearing member 40, a charging device 41 serving as a charging unit, an exposing device 34 serving as an exposing unit, which is used for irradiation with exposure light 34a, a developing device 33 serving as a developing unit, and a transfer device 45 serving as a transfer unit. The image bearing member 40 is a photosensitive member. In addition, the electrophotographic apparatus 100 is configured so that a recording medium P can be stored in a lower portion of the electrophotographic apparatus 100. The image bearing member 40 is arranged at the center position of the imaging forming unit 50. The image bearing member 40 is arranged so as to be rotatable in the arrow direction (clockwise direction in FIG. 3). The charging device 41, the exposing device 34, the developing device 33, and the transfer device 45 are arranged on the periphery of the image bearing member 40 in the stated order from an upstream side in the rotation direction of the image bearing member 40.

Toner images of a plurality of colors (e.g., four colors of black, cyan, magenta, and yellow) are successively superimposed on the recording medium P on the transfer belt 60 by each of the image forming units 50a to 50d.

The charging device 41 charges the surface (e.g., a peripheral surface) of the image bearing member 40 with positive polarity.

The exposing device 34 irradiates the charged surface of the image bearing member 40 with exposure light. That is, the exposing device 34 exposes the charged surface of the image bearing member 40 to light. Thus, an electrostatic latent image is formed on the surface of the image bearing member 40. The electrostatic latent image is formed based on image data input to the electrophotographic apparatus 100.

The developing device 33 includes toner, and supplies the toner to the surface of the image bearing member 40, to develop the electrostatic latent image as a toner image. The developing device 33 includes a developing roller 30, a layering blade 31, and a toner supply roller 32. The toner supply roller 32 supplies toner to the developing roller 30. In addition, the layering blade 31 is brought into abutment against the developing roller 30 to regulate the coating amount of the toner supplied by the toner supply roller 32 and impart charge. The developing roller 30 (e.g., the surface of the developing roller 30, more specifically, the circumferential surface of the developing roller 30) is in contact with the surface of the image bearing member 40. That is, the electrophotographic apparatus 100 adopts a contact developing system. When a developer is a one-component developer, the developing device 33 supplies toner that is a one-component developer to the electrostatic latent image formed on the image bearing member 40. When the developer is a two-component developer, the developing device 33 supplies toner among the toner and a carrier in the two-component developer to the electrostatic latent image formed on the image bearing member 40. In this manner, the image bearing member 40 bears the toner image.

The transfer belt 60 conveys the recording medium P to the position between the image bearing member 40 and the transfer device 45. The transfer belt 60 is an endless belt. The transfer belt 60 is arranged so as to be rotatable in the arrow direction (counterclockwise direction in FIG. 3). The transfer device 45 transfers the toner image developed by the developing device 33 from the surface of the image bearing member 40 to a transfer target member. The transfer target member is the recording medium P. When the toner image is transferred, the image bearing member 40 is in contact with the recording medium P. That is, the electrophotographic apparatus 100 adopts a direct transfer system. The transfer device 45 is, for example, a transfer roller. The recording medium P having the toner image transferred thereto by the transfer device 45 is conveyed to the fixing device 61 by the transfer belt 60.

The fixing device 61 is, for example, a heating roller and/or a pressure roller. The unfixed toner image having been transferred by the transfer device 45 is heated and/or pressurized by the fixing device 61. The toner image is fixed to the recording medium P by being heated and/or pressurized. As a result, an image is formed on the recording medium P.

An example of the electrophotographic apparatus has been described above, but the electrophotographic apparatus is not limited to the electrophotographic apparatus 100 described above. The electrophotographic apparatus 100 described above is a color electrophotographic apparatus, but the electrophotographic apparatus may also be a monochrome electrophotographic apparatus. In this case, it is only required that the electrophotographic apparatus include, for example, only one image forming unit.

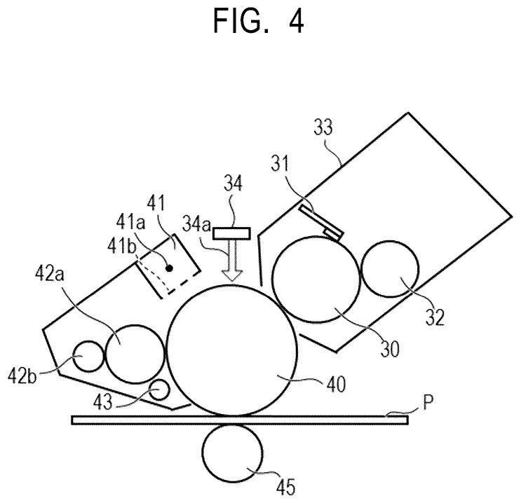

The charging device 41 includes a corona charger as a corona charging member that charges the photosensitive member 40 without being brought into contact therewith as illustrated in detail in FIG. 4. The corona charging member includes a charge control unit 41b that controls a charge potential, and a discharge electrode 41a. A metal wire having a diameter of preferably from 10 μm to 500 μm, more preferably from 50 μm to 200 μm is preferably used as the discharge electrode 41a of the corona charging member. Tungsten coated with a precious metal such as gold as required, stainless steel, or the like is used as a material for the metal wire. In addition, a needle-shaped discharge electrode may be used as the discharge electrode 41a.

When a metal wire or a needle-shaped electrode is used as the discharge electrode 41a, the charge control unit 41b such as a grid line having a voltage applied thereto like a scorotron charger is arranged between the discharge electrode 41a and the image bearing member 40 to enable the charge potential of the image bearing member 40 to be set to a desired value. As the charge control unit 41b, instead of the grid line, a configuration in which a metal thin plate made of stainless steel (SUS) or the like is etched to allow an ion flow to pass therethrough is also preferably used. In contrast, in the case of a corotron charger, the charge potential is controlled by the amount of a current. However, when high image quality is pursued, it tends to be difficult to control the charge potential. Accordingly, it is preferred that the corona charger be a scorotron charger including a discharge electrode and a grid.

In addition, the electrophotographic apparatus 100 described above adopts a tandem system, but the electrophotographic apparatus may also adopt, for example, a rotary system. The electrophotographic apparatus 100 described above adopts a contact developing system, but the electrophotographic apparatus may also adopt a non-contact developing system. The electrophotographic apparatus 100 described above adopts a direct transfer system, but the electrophotographic apparatus may also adopt an intermediate transfer system. When the electrophotographic apparatus adopts an intermediate transfer system, the transfer target member corresponds to an intermediate transfer belt.

Further, on the periphery of the image bearing member 40, a cleaning roller 42a that removes residual toner on the surface of the image bearing member 40 after transfer and a pre-exposure device 43 for eliminating charge from the image bearing member 40 are arranged. In addition, a conductor 42b that applies a voltage to the cleaning roller 42a is in abutment against the cleaning roller 42a.

### [Process Cartridge]

Next, with reference to FIG. 4, an example of a process cartridge that may be used in the present disclosure is described. The process cartridge corresponds to each of the image forming units 50a to 50d. The process cartridge includes the image bearing member 40. The image bearing member 40 is the photosensitive member. The process cartridge further includes at least one selected from the group consisting of: the charging device 41; the exposing device 34; and the developing device 33, in addition to the image bearing member 40. The process cartridge may further include a cleaning member (e.g., the cleaning roller 42a) and a charge-eliminating device (e.g., the pre-exposure device 43). The process cartridge is designed so as to be detachably attachable onto the electrophotographic apparatus 100. Thus, the process cartridge is easy to handle, and can be easily and quickly replaced together with the image bearing member 40 when the sensitivity characteristic and the like of the image bearing member 40 deteriorate.

According to the present disclosure, an electrophotographic apparatus including a corona charger and an electrophotographic photosensitive member capable of suppressing fluctuations in post-exposure potential at the time of long-term repeated use can be provided.

### EXAMPLES

The present disclosure is described below in more detail by way of Examples and Comparative Examples. The present disclosure is by no means limited by the following Examples within a scope not departing from the gist of the present disclosure. In the following description of Examples, the term “part(s)” is by mass unless otherwise specified.

### <Production of Polyester Resin>

A polyarylate resin (PAR) having a structural unit derived from a dicarboxylic acid and a structural unit derived from a bisphenol was produced as a polyester resin.

### [Synthesis of Resin (PAR-1)]

A three-necked flask including a temperature gauge, a three-way cock, and a dropping funnel was used as a reaction vessel. The following materials were loaded into the reaction vessel.
Compound (BP-1) serving as a monomer (41.0 mmol)
2,6-Dimethylphenol (DMP) serving as an end terminator (0.625 mmol)
Sodium hydroxide (98 mmol)
Benzyltributylammonium chloride (0.384 mmol)

Air in the reaction vessel was replaced by an argon gas. Water (300 mL) was added to the contents of the reaction vessel. The contents of the reaction vessel were stirred at 50° C. for 1 hour. The contents of the reaction vessel were cooled to 10° C. to provide an alkaline aqueous solution A1.

Next, a dicarboxylic acid dichloride (32.0 mmol) that was a derivative of the compound (DC-1) serving as a monomer was dissolved in chloroform (150 mL). Thus, a chloroform solution B1 was obtained.

The chloroform solution B1 was slowly dropped into the alkaline aqueous solution A1 over 110 minutes through use of the dropping funnel. The contents of the reaction vessel were stirred for 4 hours to allow a polymerization reaction to proceed while the temperature (liquid temperature) of the contents of the reaction vessel was regulated to 15±5° C. The upper layer (aqueous layer) of the contents of the reaction vessel was removed by decantation. Thus, an organic layer was obtained. Next, 400 mL of ion-exchanged water was loaded into an Erlenmeyer flask. The resultant organic layer was further added to the Erlenmeyer flask. 400 Milliliters of chloroform and 2 mL of acetic acid were further added to the Erlenmeyer flask. The contents of the Erlenmeyer flask were stirred at room temperature (25° C.) for 30 minutes. The upper layer (aqueous layer) of the contents of the Erlenmeyer flask was removed by decantation. Thus, an organic layer was obtained. The resultant organic layer was washed with 1 L of ion-exchanged water through use of a separating funnel. The washing with ion-exchanged water was repeated five times. Thus, a water-washed organic layer was obtained. Next, the water-washed organic layer was filtered to provide filtrate. The resultant filtrate was slowly dropped into 1 L of methanol to provide a precipitate. The precipitate was taken out by filtration. The precipitate thus taken out was dried in a vacuum at a temperature of 70° C. for 12 hours. As a result, a resin (PAR-1) having a viscosity-average molecular weight of 35,000 was obtained.

### [Synthesis of Resin (PAR-30)]

A three-necked flask including a temperature gauge, a three-way cock, and a dropping funnel was used as a reaction vessel. The following materials were loaded into the reaction vessel.
Compound (BP-1) serving as a monomer (20.5 mmol)
Compound (BP-2) serving as a monomer (20.5 mmol)
2,6-Dimethylphenol (DMP) serving as an end terminator (0.413 mmol)
Sodium hydroxide (98 mmol)
Benzyltributylammonium chloride (0.384 mmol)

Air in the reaction vessel was replaced by an argon gas. 300 Milliliters of water was added to the contents of the reaction vessel. The contents of the reaction vessel were stirred at 50° C. for 1 hour. The contents of the reaction vessel were cooled to 10° C. to provide an alkaline aqueous solution A2.

Next, 32.8 mmol of a dicarboxylic acid dichloride that was a derivative of the compound (DC-1) serving as a monomer, and 8.2 mmol of a dicarboxylic acid dichloride that was a derivative of the compound (DC-2) serving as a monomer were dissolved in 150 mL of chloroform. Thus, a chloroform solution B2 was obtained.

The chloroform solution B2 was slowly dropped into the alkaline aqueous solution A2 over 110 minutes through use of the dropping funnel. The contents of the reaction vessel were stirred for 4 hours to allow a polymerization reaction to proceed while the temperature (liquid temperature) of the contents of the reaction vessel was regulated to 15±5° C. The upper layer (aqueous layer) of the contents of the reaction vessel was removed by decantation. Thus, an organic layer was obtained. Next, 400 mL of ion-exchanged water was loaded into an Erlenmeyer flask. The resultant organic layer was further added to the Erlenmeyer flask. 400 Milliliters of chloroform and 2 mL of acetic acid were further added to the Erlenmeyer flask. The contents of the Erlenmeyer flask were stirred at room temperature (25° C.) for 30 minutes. The upper layer (aqueous layer) of the contents of the Erlenmeyer flask was removed by decantation. Thus, an organic layer was obtained. The resultant organic layer was washed with 1 L of ion-exchanged water through use of a separating funnel. The washing with ion-exchanged water was repeated five times. Thus, a water-washed organic layer was obtained. Next, the water-washed organic layer was filtered to provide filtrate. The resultant filtrate was slowly dropped into 1 L of methanol to provide a precipitate. The precipitate was taken out by filtration. The precipitate thus taken out was dried in a vacuum at a temperature of 70° C. for 12 hours. As a result, a resin (PAR-30) having a viscosity-average molecular weight of 53,600 was obtained.

### [Synthesis of Resins (PAR-2) to (PAR-29), (PAR-31) to (PAR-44), and (PAR-101) to (PAR-107)]

Synthesis was performed by the same method as that in the synthesis of the resin (PAR-30) except that the relative ratio of the bisphenol to the dicarboxylic acid, and the kind and usage amount of the end terminator were changed. Thus, resins having viscosity-average molecular weights shown in Tables 1, 2, and 3 were obtained. As the usage amount of the end terminator becomes smaller, the viscosity-average molecular weight of each of the resins (PARs) becomes higher.

TABLE 1

| | Dicarboxylic acid | | Bisphenol | | End | Molecular |
|---|---|---|---|---|---|---|
| Resin | DC-1 | DC-2 | BP-1 | BP-2 | terminator | weight |
| PAR-1 | 100 | 0 | 100 | 0 | DMP | 35,000 |
| PAR-2 | 100 | 0 | 100 | 0 | DMP | 55,000 |
| PAR-3 | 100 | 0 | 100 | 0 | DMP | 66,000 |
| PAR-4 | 100 | 0 | 100 | 0 | DMP | 78,000 |
| PAR-5 | 100 | 0 | 100 | 0 | DMP | 13,000 |
| PAR-6 | 100 | 0 | 100 | 0 | PFH | 66,000 |
| PAR-7 | 100 | 0 | 90 | 10 | DMP | 53,000 |
| PAR-8 | 100 | 0 | 80 | 20 | DMP | 57,000 |
| PAR-9 | 100 | 0 | 70 | 30 | DMP | 66,000 |
| PAR-10 | 100 | 0 | 60 | 40 | DMP | 68,000 |
| PAR-11 | 100 | 0 | 50 | 50 | DMP | 63,800 |
| PAR-12 | 100 | 0 | 30 | 70 | DMP | 58,000 |
| PAR-13 | 100 | 0 | 20 | 80 | DMP | 69,000 |
| PAR-14 | 100 | 0 | 10 | 90 | DMP | 51,000 |
| PAR-15 | 90 | 10 | 100 | 0 | DMP | 61,000 |
| PAR-16 | 90 | 10 | 90 | 10 | DMP | 53,000 |
| PAR-17 | 90 | 10 | 80 | 20 | DMP | 54,000 |
| PAR-18 | 90 | 10 | 70 | 30 | DMP | 67,000 |
| PAR-19 | 90 | 10 | 60 | 40 | DMP | 62,000 |
| PAR-20 | 90 | 10 | 50 | 50 | DMP | 56,000 |

TABLE 2

| | Dicarboxylic acid | | Bisphenol | | | Molecular |
|---|---|---|---|---|---|---|
| Resin | DC-1 | DC-2 | BP-1 | BP-2 | End terminator | weight |
| PAR-21 | 90 | 10 | 40 | 60 | DMP | 59,000 |
| PAR-22 | 90 | 10 | 30 | 70 | DMP | 68,000 |
| PAR-23 | 90 | 10 | 20 | 80 | DMP | 66,900 |
| PAR-24 | 90 | 10 | 10 | 90 | DMP | 51,000 |
| PAR-25 | 80 | 20 | 100 | 0 | DMP | 66,000 |
| PAR-26 | 80 | 20 | 90 | 10 | DMP | 53,000 |
| PAR-27 | 80 | 20 | 80 | 20 | DMP | 57,000 |
| PAR-28 | 80 | 20 | 70 | 30 | DMP | 66,000 |
| PAR-29 | 80 | 20 | 60 | 40 | DMP | 68,000 |
| PAR-30 | 80 | 20 | 50 | 50 | DMP | 58,000 |
| PAR-31 | 80 | 20 | 40 | 60 | DMP | 69,000 |
| PAR-32 | 80 | 20 | 30 | 70 | DMP | 51,000 |
| PAR-33 | 80 | 20 | 20 | 80 | DMP | 61,500 |
| PAR-34 | 80 | 20 | 10 | 90 | DMP | 53,000 |
| PAR-35 | 70 | 30 | 100 | 0 | DMP | 54,700 |
| PAR-36 | 70 | 30 | 90 | 10 | DMP | 67,000 |
| PAR-37 | 70 | 30 | 80 | 20 | DMP | 62,400 |
| PAR-38 | 70 | 30 | 70 | 30 | DMP | 56,000 |
| PAR-39 | 70 | 30 | 60 | 40 | DMP | 59,000 |
| PAR-40 | 70 | 30 | 50 | 50 | DMP | 68,200 |
| PAR-41 | 70 | 30 | 40 | 60 | DMP | 66,000 |
| PAR-42 | 70 | 30 | 30 | 70 | DMP | 52,000 |
| PAR-43 | 70 | 30 | 20 | 80 | PFH | 54,300 |
| PAR-44 | 70 | 30 | 10 | 90 | DMP | 53,000 |

TABLE 3

| | Dicarboxylic acid | | Bisphenol | | End | Molecular |
|---|---|---|---|---|---|---|
| Resin | DC-1 | DC-2 | BP-1 | BP-2 | terminator | weight |
| PAR-101 | 60 | 40 | 90 | 10 | DMP | 66,500 |
| PAR-102 | 60 | 40 | 50 | 50 | DMP | 51,000 |
| PAR-103 | 65 | 35 | 20 | 80 | DMP | 52,000 |
| PAR-104 | 30 | 70 | 50 | 50 | DMP | 69,000 |
| PAR-105 | 0 | 100 | 50 | 50 | DMP | 55,000 |
| PAR-106 | 50 | 50 | 0 | 100 | DMP | 60,000 |
| PAR-107 | 0 | 100 | 0 | 100 | DMP | 68,000 |

The numerical values described for bisphenols in Tables 1, 2, and 3 each indicate the ratio of the substance amount in terms of mole of each bisphenol to the total sum of the substance amounts in terms of mole of two kinds of bisphenols in each of the resins (PAR-1) to (PAR-44) and the resins (PAR-101) to (PAR-107). In addition, the numerical values of dicarboxylic acids each indicate the ratio of the substance amount in terms of mole of each dicarboxylic acid to the total sum of the substance amounts in terms of mole of two kinds of dicarboxylic acids. In addition, “PFH” represents 1H,1H-perfluoro-1-heptanol. In addition, the molecular weight indicates a viscosity-average molecular weight.

### <Production of Electrophotographic Photosensitive Member>

### [Production of Photosensitive Member 1]

The following materials were prepared.

| | | |
|---|---|---|
| Y-form crystal of titanyl phthalocyanine | 2.0 | parts by mass |
| represented by the formula (CGM-1) | | |
| serving as a charge generating substance | | |
| Hole transporting substance (H-11) | 70.0 | parts by mass |
| Electron transporting substance (E-4) | 40.0 | parts by mass |
| Additive (compound represented by the | 14.0 | parts by mass |
| formula (T-1)) | | |
| Resin (PAR-1) serving as a binder resin | 100.0 | parts by mass |
| Tetrahydrofuran serving as a solvent | 500.0 | parts by mass |

The above-mentioned materials were mixed with a rod-shaped sonic oscillator for 20 minutes to provide a dispersion liquid. The dispersion liquid was filtered through a filter having an opening of 5 μm to provide a coating liquid for a photosensitive layer. The coating liquid for a photosensitive layer was applied onto an electroconductive support (drum-shaped support made of aluminum) by a dip coating method (dip coating), and was dried with hot air at 120° C. for 50 minutes. Thus, a photosensitive layer (thickness: 30 μm) was formed on the electroconductive support to provide a photosensitive member 1.

### (Resin Component Analysis of Photosensitive Member 1)

A ¹H-NMR spectrum was obtained by ¹H-nuclear magnetic resonance spectrometry of polymer components recovered from the resultant photosensitive member in deuterated chloroform. The resultant ¹H-NMR spectrum had peaks at 8.22±0.02 ppm, 7.18±0.02 ppm, 7.16±0.02 ppm, 7.10±0.02 ppm, 7.06±0.02 ppm, and 7.04±0.02 ppm. Thus, it was identified that the photosensitive member had the structural unit represented by the formula (1) and the structural unit represented by the formula (2). In addition, a ratio between the substance amounts in terms of mole of the structural unit represented by the formula (1) and the structural unit represented by the formula (2) was 1:1 as shown in Table 1 based on the integration ratios of the above-mentioned peaks.

### [Production of Photosensitive Members 2 to 90 and 101 to 107]

Photosensitive members 2 to 90 and 101 to 107 were each produced by the same method as that in the production of the photosensitive member 1 except that the kinds of the charge generating substance, the additive, the hole transporting substance, the electron transporting substance, and the binder resin were changed. The kinds of the charge generating substance, the additive, the hole transporting substance, the electron transporting substance, and the binder resin used are shown in Tables 4, 5, and 6. The mass of each of the materials used is the same as that of the photosensitive member 1. Production examples of the photosensitive members are shown in Tables 4, 5, and 6. In the tables, “CGM”, “HTM”, and “ETM” represent a charge generating substance, a hole transporting substance, and an electron transporting substance, respectively, and show compound numbers, respectively. In addition, the value of a ratio described for the resin is the value of the mass ratio of each of a resin 1 and a resin 2 in the entire binder resin.

### (Resin Component Analysis of Photosensitive Member 16)

A ¹H-NMR spectrum was obtained by ¹H-nuclear magnetic resonance spectrometry of polymer components recovered from the resultant photosensitive member in deuterated chloroform. The resultant ¹H-NMR spectrum had peaks at 8.22±0.02 ppm, 7.18±0.02 ppm, 7.16±0.02 ppm, 7.10±0.02 ppm, 7.06±0.02 ppm, 7.04±0.02 ppm, 2.28±0.02 ppm, 2.20±0.02 ppm, 1.59±0.02 ppm, and 1.54±0.02 ppm. Thus, it was identified that the photosensitive member had the structural unit represented by the formula (1), the structural unit represented by the formula (2), the structural unit represented by the formula (3), and the structural unit represented by the formula (4). In addition, the ratios of the substance amounts in terms of mole of the structural unit represented by the formula (1), the structural unit represented by the formula (2), the structural unit represented by the formula (3), and the structural unit represented by the formula (4) were as shown in Table 1 based on the integration ratios of the above-mentioned peaks.

### <Measurement of Vickers Hardness>

The produced photosensitive members shown in Tables 4, 5, and 6 were each measured for the Vickers hardness of the photosensitive layer. Specifically, the Vickers hardness of the photosensitive layer was measured by a method in conformity with Japanese Industrial Standards (JIS) Z2244. For the measurement of the Vickers hardness, a hardness meter (“Micro Vickers Hardness Tester DMH-1”, manufactured by Matsuzawa Co., Ltd. (formerly Matsuzawa Seiki Co., Ltd.)) was used. The measurement of the Vickers hardness was performed under the conditions of a temperature of 23° C., a diamond indenter load (test force) of 10 gf, a time required to reach the test force of 5 seconds, a diamond indenter approach speed of 2 mm/sec. and a test force holding time of 1 second. The measured Vickers hardness is shown in Tables 4, 5, and 6.

TABLE 4

| | Resin 1 | | Resin 2 | | | | | | |
|---|---|---|---|---|---|---|---|---|---|
| | Kind | Ratio | Kind | Ratio | CGM | HTM | ETM | Additive | Hardness |
| Photosensitive member-1 | PAR-1 | 100 | — | — | CGM-1 | H-11 | E-4 | T-1 | 24.0 |
| Photosensitive member-2 | PAR-2 | 100 | — | — | CGM-1 | H-11 | E-4 | T-1 | 24.7 |
| Photosensitive member-3 | PAR-3 | 100 | — | — | CGM-1 | H-11 | E-4 | T-1 | 24.9 |
| Photosensitive member-4 | PAR-4 | 100 | — | — | CGM-1 | H-11 | E-4 | T-1 | 25.1 |
| Photosensitive member-5 | PAR-5 | 100 | — | — | CGM-1 | H-11 | E-4 | T-1 | 20.6 |
| Photosensitive member-6 | PAR-6 | 100 | — | — | CGM-1 | H-11 | E-4 | T-1 | 24.9 |
| Photosensitive member-7 | PAR-7 | 100 | — | — | CGM-1 | H-11 | E-4 | T-1 | 24.1 |
| Photosensitive member-8 | PAR-8 | 100 | — | — | CGM-1 | H-11 | E-4 | T-1 | 23.6 |
| Photosensitive member-9 | PAR-9 | 100 | — | — | CGM-1 | H-11 | E-4 | T-1 | 23.1 |
| Photosensitive member-10 | PAR-10 | 100 | — | — | CGM-1 | H-11 | E-4 | T-1 | 22.6 |
| Photosensitive member-11 | PAR-11 | 100 | — | — | CGM-1 | H-11 | E-4 | T-1 | 21.9 |
| Photosensitive member-12 | PAR-12 | 100 | — | — | CGM-1 | H-11 | E-4 | T-1 | 20.6 |
| Photosensitive member-13 | PAR-13 | 100 | — | — | CGM-1 | H-11 | E-4 | T-1 | 20.2 |
| Photosensitive member-14 | PAR-14 | 100 | — | — | CGM-1 | H-11 | E-4 | T-1 | 19.2 |
| Photosensitive member-15 | PAR-15 | 100 | — | — | CGM-1 | H-11 | E-4 | T-1 | 24.3 |
| Photosensitive member-16 | PAR-16 | 100 | — | — | CGM-1 | H-11 | E-4 | T-1 | 23.5 |
| Photosensitive member-17 | PAR-17 | 100 | — | — | CGM-1 | H-11 | E-4 | T-1 | 23.0 |
| Photosensitive member-18 | PAR-18 | 100 | — | — | CGM-1 | H-11 | E-4 | T-1 | 22.7 |
| Photosensitive member-19 | PAR-19 | 100 | — | — | CGM-1 | H-11 | E-4 | T-1 | 22.1 |
| Photosensitive member-20 | PAR-20 | 100 | — | — | CGM-1 | H-11 | E-4 | T-1 | 21.5 |
| Photosensitive member-21 | PAR-21 | 100 | — | — | CGM-1 | H-11 | E-4 | T-1 | 21.0 |
| Photosensitive member-22 | PAR-22 | 100 | — | — | CGM-1 | H-11 | E-4 | T-1 | 20.6 |
| Photosensitive member-23 | PAR-23 | 100 | — | — | CGM-1 | H-11 | E-4 | T-1 | 20.0 |
| Photosensitive member-24 | PAR-24 | 100 | — | — | CGM-1 | H-11 | E-4 | T-1 | 19.2 |
| Photosensitive member-25 | PAR-25 | 100 | — | — | CGM-1 | H-11 | E-4 | T-1 | 23.7 |
| Photosensitive member-26 | PAR-26 | 100 | — | — | CGM-1 | H-11 | E-4 | T-1 | 23.0 |
| Photosensitive member-27 | PAR-27 | 100 | — | — | CGM-1 | H-11 | E-4 | T-1 | 22.6 |
| Photosensitive member-28 | PAR-28 | 100 | — | — | CGM-1 | H-11 | E-4 | T-1 | 22.3 |
| Photosensitive member-29 | PAR-29 | 100 | — | — | CGM-1 | H-11 | E-4 | T-1 | 21.9 |
| Photosensitive member-30 | PAR-30 | 100 | — | — | CGM-1 | H-11 | E-4 | T-1 | 21.2 |

TABLE 5

| | Resin 1 | | Resin 2 | | | | | | |
|---|---|---|---|---|---|---|---|---|---|
| | Kind | Ratio | Kind | Ratio | CGM | HTM | ETM | Additive | Hardness |
| Photosensitive member-31 | PAR-31 | 100 | — | — | CGM-1 | H-11 | E-4 | T-1 | 20.9 |
| Photosensitive member-32 | PAR-32 | 100 | — | — | CGM-1 | H-11 | E-4 | T-1 | 20.1 |
| Photosensitive member-33 | PAR-33 | 100 | — | — | CGM-1 | H-11 | E-4 | T-1 | 19.8 |
| Photosensitive member-34 | PAR-34 | 100 | — | — | CGM-1 | H-11 | E-4 | T-1 | 19.2 |
| Photosensitive member-35 | PAR-35 | 100 | — | — | CGM-1 | H-11 | E-4 | T-1 | 22.9 |
| Photosensitive member-36 | PAR-36 | 100 | — | — | CGM-1 | H-11 | E-4 | T-1 | 22.7 |
| Photosensitive member-37 | PAR-37 | 100 | — | — | CGM-1 | H-11 | E-4 | T-1 | 22.2 |
| Photosensitive member-38 | PAR-38 | 100 | — | — | CGM-1 | H-11 | E-4 | T-1 | 21.7 |
| Photosensitive member-39 | PAR-39 | 100 | — | — | CGM-1 | H-11 | E-4 | T-1 | 21.3 |
| Photosensitive member-40 | PAR-40 | 100 | — | — | CGM-1 | H-11 | E-4 | T-1 | 21.1 |
| Photosensitive member-41 | PAR-41 | 100 | — | — | CGM-1 | H-11 | E-4 | T-1 | 20.6 |
| Photosensitive member-42 | PAR-42 | 100 | — | — | CGM-1 | H-11 | E-4 | T-1 | 19.9 |
| Photosensitive member-43 | PAR-43 | 100 | — | — | CGM-1 | H-11 | E-4 | T-1 | 19.6 |
| Photosensitive member-44 | PAR-44 | 100 | — | — | CGM-1 | H-11 | E-4 | T-1 | 19.1 |
| Photosensitive member-45 | PAR-3 | 100 | — | — | CGM-1 | H-1 | E-4 | T-1 | 24.8 |
| Photosensitive member-46 | PAR-3 | 100 | — | — | CGM-1 | H-5 | E-4 | T-1 | 24.8 |
| Photosensitive member-47 | PAR-3 | 100 | — | — | CGM-1 | H-8 | E-4 | T-1 | 24.8 |
| Photosensitive member-48 | PAR-3 | 100 | — | — | CGM-1 | H-10 | E-4 | T-1 | 24.8 |
| Photosensitive member-49 | PAR-3 | 100 | — | — | CGM-1 | H-11 | E-1 | T-1 | 24.8 |
| Photosensitive member-50 | PAR-3 | 100 | — | — | CGM-1 | H-11 | E-2 | T-1 | 24.8 |
| Photosensitive member-51 | PAR-3 | 100 | — | — | CGM-1 | H-11 | E-6 | T-1 | 24.8 |
| Photosensitive member-52 | PAR-3 | 100 | — | — | CGM-1 | H-11 | E-7 | T-1 | 24.8 |
| Photosensitive member-53 | PAR-3 | 100 | — | — | CGM-1 | H-11 | E-8 | T-1 | 24.8 |
| Photosensitive member-54 | PAR-3 | 100 | — | — | CGM-1 | H-11 | E-4 | — | 24.7 |
| Photosensitive member-55 | PAR-22 | 100 | — | — | CGM-1 | H-1 | E-4 | T-1 | 20.6 |
| Photosensitive member-56 | PAR-22 | 100 | — | — | CGM-1 | H-5 | E-4 | T-1 | 20.6 |
| Photosensitive member-57 | PAR-22 | 100 | — | — | CGM-1 | H-8 | E-4 | T-1 | 20.6 |
| Photosensitive member-58 | PAR-22 | 100 | — | — | CGM-1 | H-10 | E-4 | T-1 | 20.6 |
| Photosensitive member-59 | PAR-22 | 100 | — | — | CGM-1 | H-11 | E-1 | T-1 | 20.6 |
| Photosensitive member-60 | PAR-22 | 100 | — | — | CGM-1 | H-11 | E-2 | T-1 | 20.6 |
| Photosensitive member-61 | PAR-22 | 100 | — | — | CGM-1 | H-11 | E-6 | T-1 | 20.6 |
| Photosensitive member-62 | PAR-22 | 100 | — | — | CGM-1 | H-11 | E-7 | T-1 | 20.6 |
| Photosensitive member-63 | PAR-22 | 100 | — | — | CGM-1 | H-11 | E-8 | T-1 | 20.6 |
| Photosensitive member-64 | PAR-22 | 100 | — | — | CGM-1 | H-11 | E-4 | — | 20.5 |
| Photosensitive member-65 | PAR-32 | 100 | — | — | CGM-1 | H-1 | E-4 | T-1 | 20.1 |
| Photosensitive member-66 | PAR-32 | 100 | — | — | CGM-1 | H-5 | E-4 | T-1 | 20.1 |
| Photosensitive member-67 | PAR-32 | 100 | — | — | CGM-1 | H-8 | E-4 | T-1 | 20.1 |
| Photosensitive member-68 | PAR-32 | 100 | — | — | CGM-1 | H-10 | E-4 | T-1 | 20.1 |
| Photosensitive member-69 | PAR-32 | 100 | — | — | CGM-1 | H-11 | E-1 | T-1 | 20.1 |
| Photosensitive member-70 | PAR-32 | 100 | — | — | CGM-1 | H-11 | E-2 | T-1 | 20.1 |

TABLE 6

| | Resin 1 | | Resin 2 | | | | | | |
|---|---|---|---|---|---|---|---|---|---|
| | Kind | Ratio | Kind | Ratio | CGM | HTM | ETM | Additive | Hardness |
| Photosensitive member-71 | PAR-32 | 100 | — | — | CGM-1 | H-11 | E-6 | T-1 | 20.1 |
| Photosensitive member-72 | PAR-32 | 100 | — | — | CGM-1 | H-11 | E-7 | T-1 | 20.1 |
| Photosensitive member-73 | PAR-32 | 100 | — | — | CGM-1 | H-11 | E-8 | T-1 | 20.1 |
| Photosensitive member-74 | PAR-32 | 100 | — | — | CGM-1 | H-11 | E-4 | — | 20 |
| Photosensitive member-75 | PAR-42 | 100 | — | — | CGM-1 | H-1 | E-4 | T-1 | 19.8 |
| Photosensitive member-76 | PAR-42 | 100 | — | — | CGM-1 | H-5 | E-4 | T-1 | 19.8 |
| Photosensitive member-77 | PAR-42 | 100 | — | — | CGM-1 | H-8 | E-4 | T-1 | 19.8 |
| Photosensitive member-78 | PAR-42 | 100 | — | — | CGM-1 | H-10 | E-4 | T-1 | 19.8 |
| Photosensitive member-79 | PAR-42 | 100 | — | — | CGM-1 | H-11 | E-1 | T-1 | 19.8 |
| Photosensitive member-80 | PAR-42 | 100 | — | — | CGM-1 | H-11 | E-2 | T-1 | 19.8 |
| Photosensitive member-81 | PAR-42 | 100 | — | — | CGM-1 | H-11 | E-6 | T-1 | 19.8 |
| Photosensitive member-82 | PAR-42 | 100 | — | — | CGM-1 | H-11 | E-7 | T-1 | 19.8 |
| Photosensitive member-83 | PAR-42 | 100 | — | — | CGM-1 | H-11 | E-8 | T-1 | 19.8 |
| Photosensitive member-84 | PAR-42 | 100 | — | — | CGM-1 | H-11 | E-4 | — | 19.8 |
| Photosensitive member-85 | PAR-22 | 55 | PAR-107 | 45 | CGM-1 | H-11 | E-8 | T-1 | 19.9 |
| Photosensitive member-86 | PAR-32 | 55 | PAR-107 | 45 | CGM-1 | H-11 | E-8 | T-1 | 19.6 |
| Photosensitive member-87 | PAR-42 | 55 | PAR-107 | 45 | CGM-1 | H-11 | E-8 | T-1 | 19.5 |
| Photosensitive member-88 | PAR-22 | 45 | PAR-107 | 55 | CGM-1 | H-11 | E-8 | T-1 | 19.7 |
| Photosensitive member-89 | PAR-32 | 45 | PAR-107 | 55 | CGM-1 | H-11 | E-8 | T-1 | 19.5 |
| Photosensitive member-90 | PAR-42 | 45 | PAR-107 | 55 | CGM-1 | H-11 | E-8 | T-1 | 19.4 |
| Photosensitive member- | PAR-101 | 100 | — | — | CGM-1 | H-11 | E-4 | T-1 | 22.2 |
| 101 | | | | | | | | | |
| Photosensitive member- | PAR-102 | 100 | — | — | CGM-1 | H-11 | E-4 | T-1 | 20.4 |
| 102 | | | | | | | | | |
| Photosensitive member- | PAR-103 | 100 | — | — | CGM-1 | H-11 | E-4 | T-1 | 19.4 |
| 103 | | | | | | | | | |
| Photosensitive member- | PAR-104 | 100 | — | — | CGM-1 | H-11 | E-4 | T-1 | 19.9 |
| 104 | | | | | | | | | |
| Photosensitive member- | PAR-105 | 100 | — | — | CGM-1 | H-11 | E-4 | T-1 | 18.7 |
| 105 | | | | | | | | | |
| Photosensitive member- | PAR-106 | 100 | — | — | CGM-2 | H-11 | E-5 | T-2 | 18.8 |
| 106 | | | | | | | | | |
| Photosensitive member- | PAR-107 | 100 | — | — | CGM-3 | H-11 | E-6 | T-3 | 19.0 |
| 107 | | | | | | | | | |

### [Evaluations]

A monochrome laser printer HL-5200 manufactured by Brother Industries, Ltd. was modified as an electrophotographic apparatus. A high-voltage power supply control system (product name: Model 615-3, manufactured by Trek Japan) was used as a power supply for supplying power for a corona charger from the outside of the printer. An electrophotographic photosensitive member of a drum unit in a cartridge for this printer was removed, and a photosensitive member 1 was set instead. This image forming apparatus was left to stand under an environment at a temperature of 10° C. and a humidity of 15% RH for 24 hours or more, and the following evaluations were performed.

### <Evaluations of Charging Stability and Sensitivity Stability of Photosensitive Member>

First, an entirely blank image was printed on three sheets of recording media (A4-size paper) with an evaluation machine. When printing was performed on each of the sheets, the surface potential of the photosensitive member was measured at a developing position. No exposure is performed when a blank image is printed, and hence the measured surface potential corresponds to a charge potential. The surface potential was measured once per printed sheet, a total of three times. The average value of the three measured surface potentials was defined as a charge potential V_{D0} (unit: +V) before a print test.

In addition, an entirely black image was similarly printed on three sheets, and the surface potential was measured at a developing position. Exposure is performed when an entirely black image is printed, and hence the measured surface potential corresponds to a post-exposure potential. The surface potential was measured once per printed sheet, a total of three times. The average value of the three measured surface potentials was defined as a post-exposure potential V_{L0} (unit: +V) before a print test.

Next, a print test was performed. The print test involved printing a print pattern image with a print percentage of 3% on 30,000 sheets of recording media (A4-size paper) with an evaluation machine. Immediately after the print test, an entirely blank image was printed. When printing was performed on each of the sheets, the surface potential of the photosensitive member was measured at a developing position. The surface potential was measured once per printed sheet, a total of three times. The average value of the three measured surface potentials was defined as a charge potential Vai (unit: +V) after the print test.

In addition, under a state in which the charge potential was adjusted so that the initial charge potential was the charge potential V_{d0}, an entirely black image was printed on three sheets. In addition, an entirely black image was similarly printed on three sheets, and the surface potential was measured at a developing position. The surface potential was measured once per printed sheet, a total of three times. The average value of the three measured surface potentials was defined as a post-exposure potential V_{L1} (unit: +V) after the print test.

An absolute value of a difference (V_{d0}-V_{d1}) obtained by subtracting the charge potential Vai after the print test from the charge potential V_{d0} before the print test was defined as a charge potential decrease amount ΔV_{d} (unit: V). The charge potential decrease amount ΔV_{d} is shown in Table 7. A smaller charge potential decrease amount ΔV_{d} (unit: V) indicates that the charging stability of the photosensitive member is more excellent. A photosensitive member having a charge potential decrease amount ΔV_{d} (unit: V) of 20 V or more was evaluated as having unsatisfactory charging stability.

In addition, an absolute value of a difference (V_{L0}-V_{L1}) obtained by subtracting the post-exposure potential V_{L1} after the print test from the post-exposure potential V_{L0} before the print test was defined as a post-exposure potential variation ΔV_{L} (unit: V). The post-exposure potential variation ΔV_{L} is shown in Table 7. A smaller post-exposure potential variation ΔV_{L} (unit: V) indicates that the sensitivity stability of the photosensitive member is more excellent. A photosensitive member having a post-exposure potential variation ΔV_{L} (unit: V) of 30 V or more was evaluated as having unsatisfactory sensitivity stability.

TABLE 7

| | Photosensitive member No. | ΔV_{d} | ΔV_{L} |
|---|---|---|---|
| Example 1 | Photosensitive member-1 | 12.2 | 26.6 |
| Example 2 | Photosensitive member-3 | 11.5 | 26.7 |
| Example 3 | Photosensitive member-5 | 15.4 | 27.3 |
| Example 4 | Photosensitive member-8 | 12.1 | 25.8 |
| Example 5 | Photosensitive member-12 | 13.1 | 23.4 |
| Example 6 | Photosensitive member-15 | 11.3 | 25.2 |
| Example 7 | Photosensitive member-18 | 11.5 | 23.0 |
| Example 8 | Photosensitive member-22 | 12.0 | 21.3 |
| Example 9 | Photosensitive member-25 | 12.0 | 25.6 |
| Example 10 | Photosensitive member-28 | 11.5 | 22.4 |
| Example 11 | Photosensitive member-32 | 10.8 | 18.7 |
| Example 12 | Photosensitive member-35 | 12.4 | 25.2 |
| Example 13 | Photosensitive member-38 | 12.1 | 22.8 |
| Example 14 | Photosensitive member-42 | 12.0 | 20.6 |
| Example 15 | Photosensitive member-47 | 11.8 | 27.1 |
| Example 16 | Photosensitive member-53 | 11.7 | 26.9 |
| Example 17 | Photosensitive member-57 | 12.2 | 21.7 |
| Example 18 | Photosensitive member-63 | 12.3 | 21.9 |
| Example 19 | Photosensitive member-65 | 11.1 | 19.3 |
| Example 20 | Photosensitive member-67 | 11.0 | 19.1 |
| Example 21 | Photosensitive member-70 | 10.9 | 18.9 |
| Example 22 | Photosensitive member-71 | 11.2 | 19.4 |
| Example 23 | Photosensitive member-73 | 10.9 | 18.9 |
| Example 24 | Photosensitive member-74 | 12.9 | 22.3 |
| Example 25 | Photosensitive member-77 | 12.2 | 20.8 |
| Example 26 | Photosensitive member-83 | 12.3 | 20.9 |
| Example 27 | Photosensitive member-86 | 14.5 | 25.4 |
| Example 28 | Photosensitive member-89 | 15.7 | 28.2 |
| Comparative | Photosensitive member-101 | 16.2 | 48.5 |
| Example 1 | | | |
| Comparative | Photosensitive member-102 | 17.1 | 45.4 |
| Example 2 | | | |
| Comparative | Photosensitive member-103 | 15.4 | 44.9 |
| Example 3 | | | |
| Comparative | Photosensitive member-104 | 20.3 | 46.2 |
| Example 4 | | | |
| Comparative | Photosensitive member-105 | 33.5 | 49.3 |
| Example 5 | | | |
| Comparative | Photosensitive member-106 | 28.6 | 55.2 |
| Example 6 | | | |
| Comparative | Photosensitive member-107 | 36.4 | 58.1 |
| Example 7 | | | |

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-159483, filed Sep. 13, 2024, which is hereby incorporated by reference herein in its entirety.

What is claimed is:

1. An electrophotographic apparatus comprising:
an electrophotographic photosensitive member; and
a corona charger configured to positively charge the electrophotographic photosensitive member,
wherein the electrophotographic photosensitive member includes a monolayer type photosensitive layer,
wherein the photosensitive layer contains a charge generating substance, a hole transporting substance, an electron transporting substance, and a binder resin,
wherein the binder resin contains a polyester resin having a structural unit represented by the following formula (a) and a structural unit represented by the following formula (1), and
wherein 70 mol % or more of the structural unit represented by the following formula (a) in the polyester resin is a structural unit represented by the following formula (2): 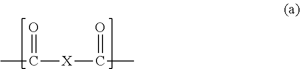
in the formula (a), X represents a divalent organic group free of an ester bond,

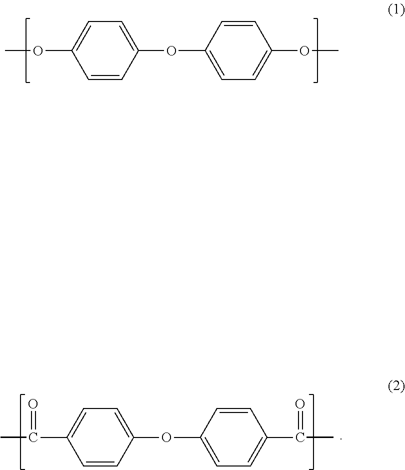

2. The electrophotographic apparatus according to claim 1, wherein the polyester resin further has a structural unit represented by the following formula (3):

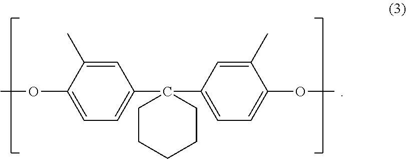

3. The electrophotographic apparatus according to claim 1, wherein the polyester resin further has a structural unit represented by the following formula (4) as the structural unit represented by the formula (a):

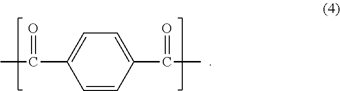

4. The electrophotographic apparatus according to claim 2, wherein, when a ratio of a substance amount in terms of mole of the structural unit represented by the formula (1) with respect to a total sum of substance amounts in terms of mole of the structural units for forming the polyester resin is represented by M1 and a ratio of a substance amount in terms of mole of the structural unit represented by the formula (3) with respect to the total sum of substance amounts in terms of mole of the structural units for forming the polyester resin is represented by M3, the M1 and the M3 satisfy a relationship represented by 0<M1/(M1+M3)≤0.5.

5. The electrophotographic apparatus according to claim 1, wherein a ratio of the polyester resin is 50 mass % or more with respect to a total mass of the binder resin.

6. The electrophotographic apparatus according to claim 1, wherein the electron transporting substance contains at least one compound selected from the group consisting of: a compound represented by the following formula (10); a compound represented by the following formula (11); a compound represented by the following formula (12); a compound represented by the following formula (13); a compound represented by the following formula (14); a compound represented by the following formula (15); and a compound represented by the following formula (16): 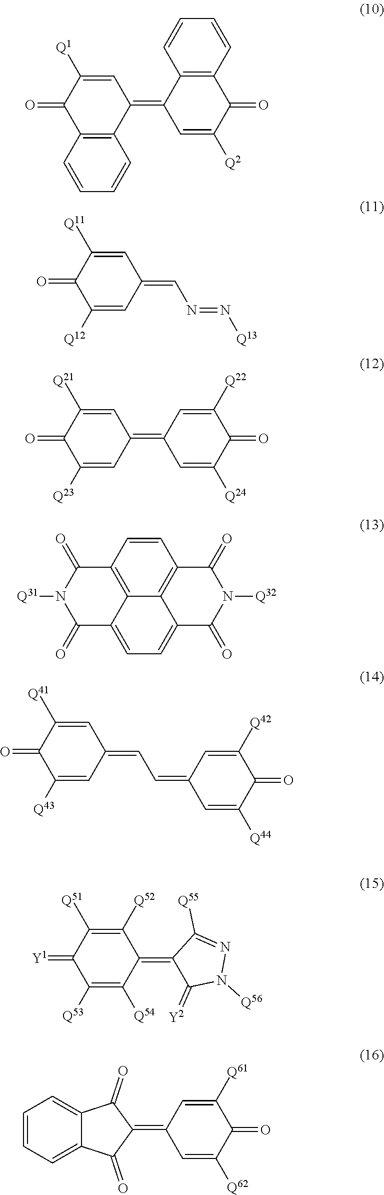
where Q¹ and Q² in the formula (10), Q¹¹, Q¹², and Q¹³ in the formula (11), Q²¹, Q²², Q²³, and Q²⁴ in the formula (12), Q³¹ and Q³² in the formula (13), Q⁴¹, Q⁴², Q⁴³, and Q⁴⁴ in the formula (14), Q⁵¹, Q⁵², Q⁵³, Q⁵⁴, Q⁵⁵, and Q⁵⁶ in the formula (15), and Q⁶¹ and Q⁶² in the formula (16) each independently represent a hydrogen atom, a halogen atom, a cyano group, an alkyl group having 1 or more and 6 or less carbon atoms, an alkenyl group having 2 or more and 6 or less carbon atoms, an alkoxy group having 1 or more and 6 or less carbon atoms, or an aryl group having 6 or more and 14 or less carbon atoms that may be substituted with at least one substituent selected from the group consisting of: an alkyl group having 1 or more and 6 or less carbon atoms; and a halogen atom, and Y¹ and Y² in the formula (15) each independently represent an oxygen atom or a sulfur atom.

7. The electrophotographic apparatus according to claim 6, wherein the electron transporting substance contains at least one compound selected from the group consisting of: a compound represented by the following formula (E-1); a compound represented by the following formula (E-2); a compound represented by the following formula (E-3); a compound represented by the following formula (E-4); a compound represented by the following formula (E-5); a compound represented by the following formula (E-6); a compound represented by the following formula (E-7); and a compound represented by the following formula (E-8):

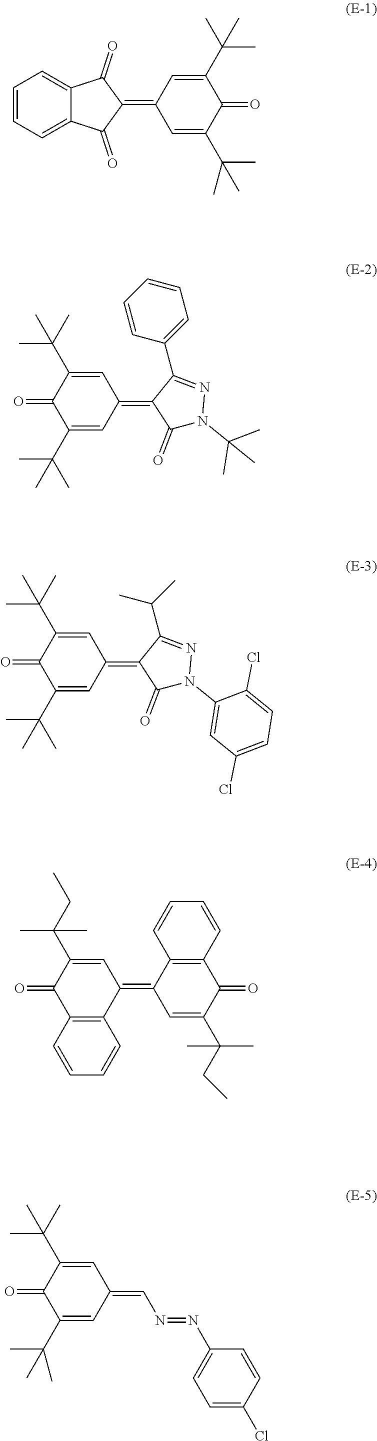

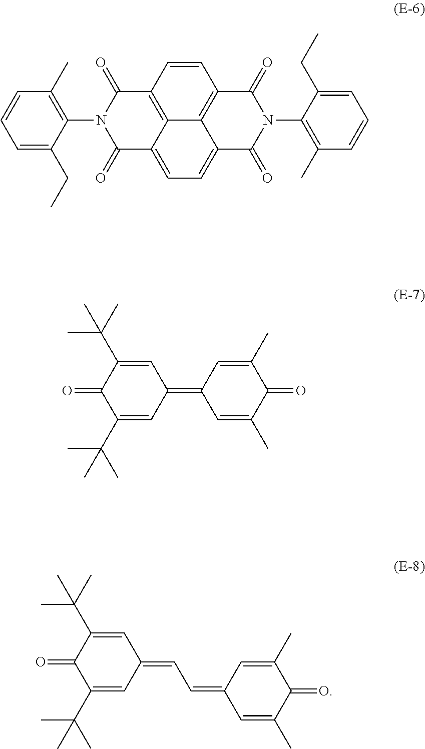 [SMILES: CCc1cccc(C)c1N1C(=O)c2ccc3c4c(ccc(c24)C1=O)C(=O)N(c1c(C)cccc1CC)C3=O ; CC1=CC(=C2C=C(C(C)(C)C)C(=O)C(C(C)(C)C)=C2)C=C(C)C1=O ; CC1=CC(=CC=C2C=C(C(C)(C)C)C(=O)C(C(C)(C)C)=C2)C=C(C)C1=O]

8. The electrophotographic apparatus according to claim 1, wherein the hole transporting substance contains at least one compound selected from the group consisting of: a compound represented by the following formula (20); a compound represented by the following formula (21); a compound represented by the following formula (22); a compound represented by the following formula (23); and a compound represented by the following formula (24): 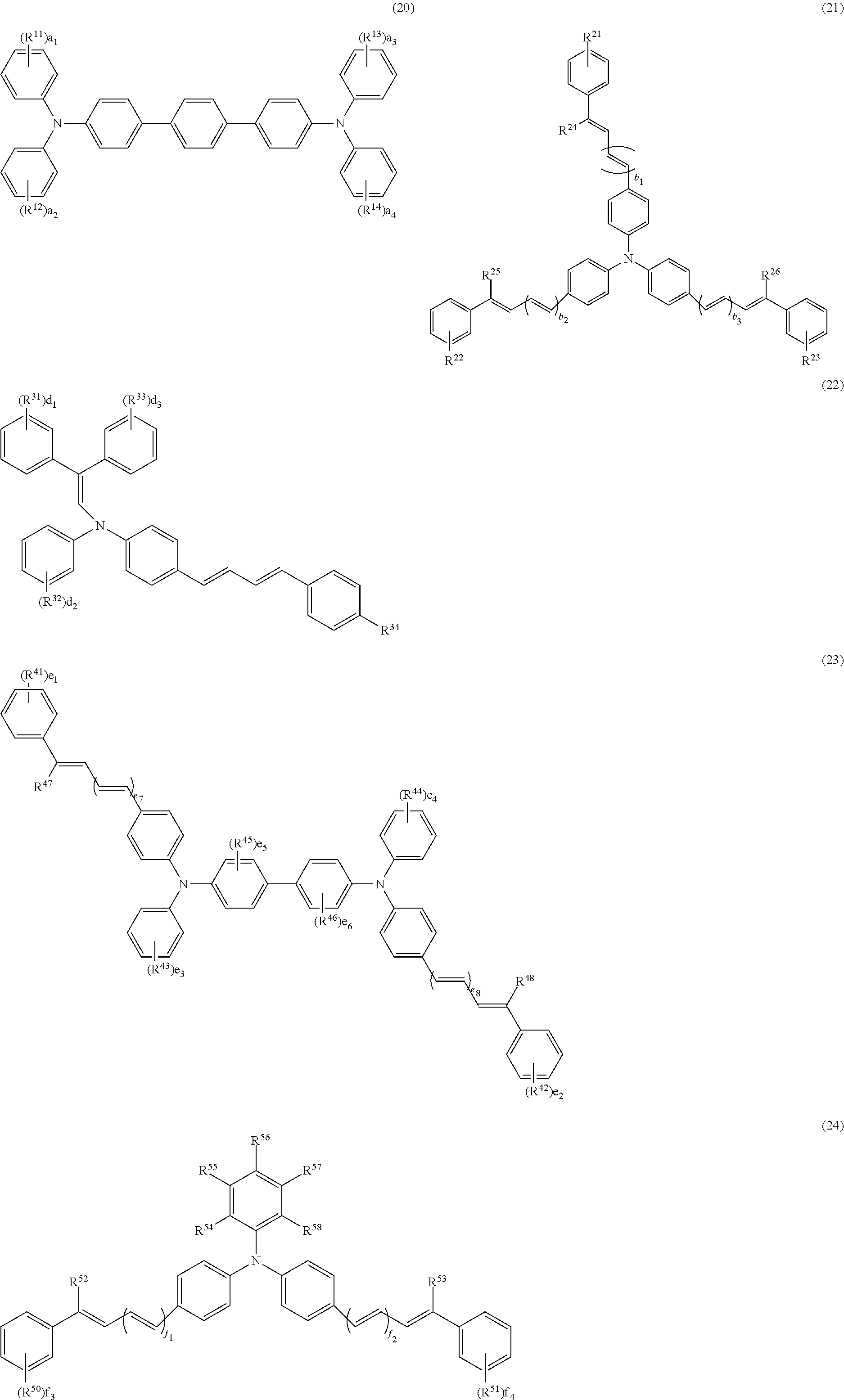
in the formula (20), R¹¹, R¹², R¹³, and R¹⁴ each independently represent an alkyl group having 1 or more and 6 or less carbon atoms, or an alkoxy group having 1 or more and 6 or less carbon atoms, and a₁, a₂, a₃, and a₄ each independently represent an integer of 0 or more and 5 or less; in the formula (21), R²¹, R²², and R²³ each independently represent an alkyl group having 1 or more and 6 or less carbon atoms, R²⁴, R²⁵, and R²⁶ each independently represent a hydrogen atom, or an alkyl group having 1 or more and 6 or less carbon atoms, and b₁, b₂, and b₃ each independently represent 0 or 1; in the formula (22), R³¹, R³², and R³³ each independently represent an alkyl group having 1 or more and 6 or less carbon atoms, R³⁴ represents an alkyl group having 1 or more and 6 or less carbon atoms, or a hydrogen atom, and d₁, d₂, and d₃ each independently represent an integer of 0 or more and 5 or less; in the formula (23), R⁴¹, R⁴², R⁴³, R⁴⁴, R⁴⁵, and R⁴⁶ each independently represent an alkyl group having 1 or more and 6 or less carbon atoms, or a phenyl group, R⁴⁷ and R⁴⁸ each independently represent a hydrogen atom, an alkyl group having 1 or more and 6 or less carbon atoms, or a phenyl group, e₁, e₂, e₃, and e₄ each independently represent an integer of 0 or more and 5 or less, e₅ and e₆ each independently represent an integer of 0 or more and 4 or less, and e₇ and e₈ each independently represent 0 or 1; and in the formula (24), R⁵⁰ and R⁵¹ each independently represent an alkyl group having 1 or more and 6 or less carbon atoms, an alkoxy group having 1 or more and 6 or less carbon atoms, or a phenyl group, R⁵², R⁵³, R⁵⁴, R⁵⁵, R⁵⁶, R⁵⁷, and R⁵⁸ each independently represent a hydrogen atom, an alkyl group having 1 or more and 6 or less carbon atoms, an alkoxy group having 1 or more and 6 or less carbon atoms, or a phenyl group that may be substituted with an alkyl group having 1 or more and 6 or less carbon atoms, f₁ and f₂ each independently represent an integer of 0 or more and 2 or less, and f₃ and f₄ each independently represent an integer of 0 or more and 5 or less.

9. The electrophotographic apparatus according to claim 8, wherein the hole transporting substance contains at least one compound selected from the group consisting of: a compound represented by the following formula (H-1); a compound represented by the following formula (H-2); a compound represented by the following formula (H-3); a compound represented by the following formula (H-4); a compound represented by the following formula (H-5); a compound represented by the following formula (H-6); a compound represented by the following formula (H-7); a compound represented by the following formula (H-8); a compound represented by the following formula (H-9); a compound represented by the following formula (H-10); and a compound represented by the following formula (H-11):

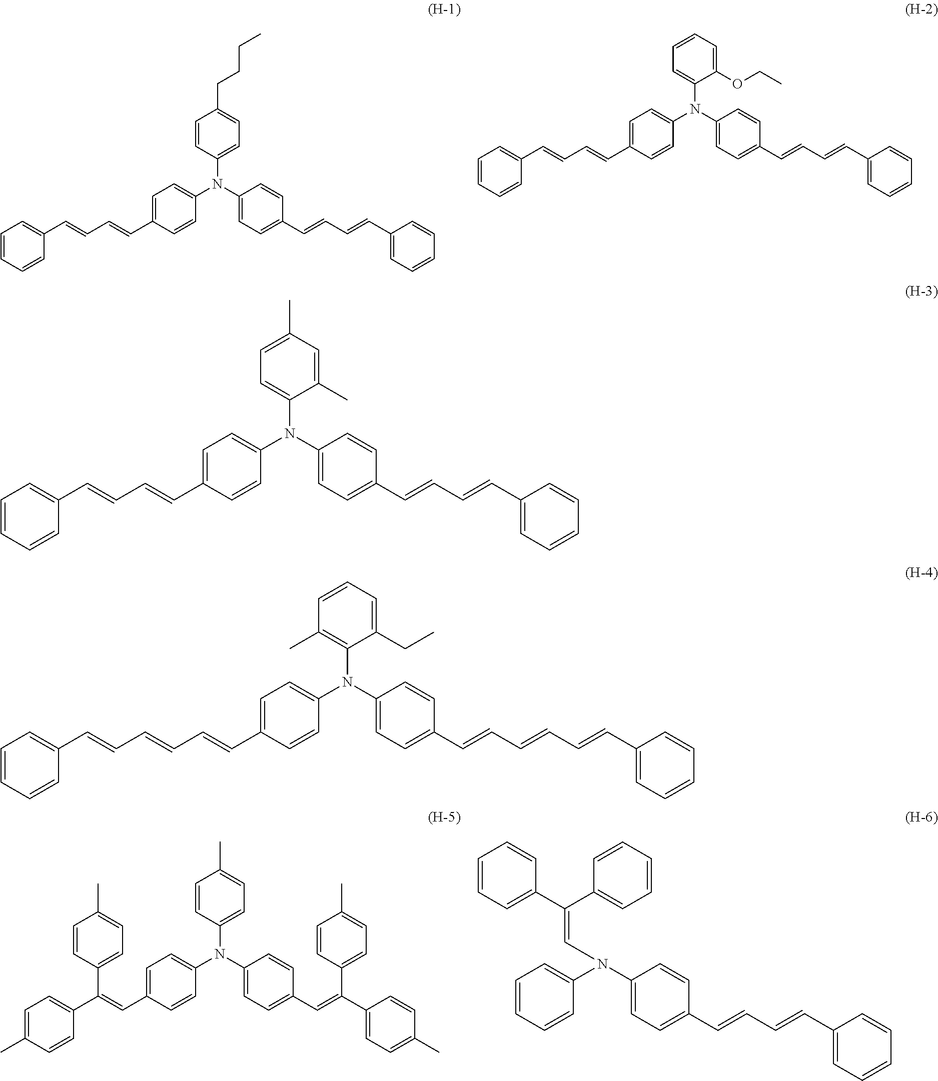

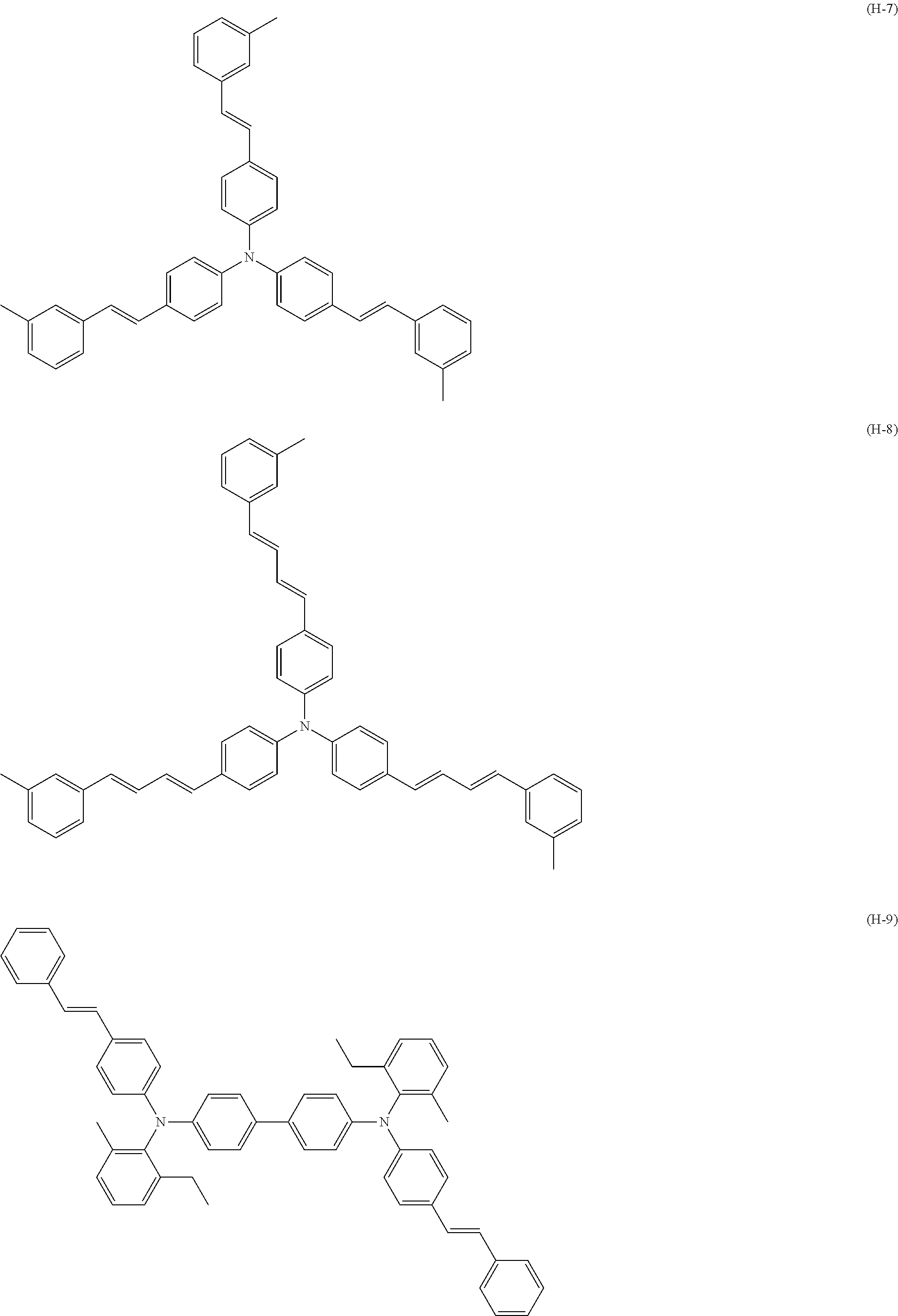 [SMILES: Cc1cccc(/C=C/c2ccc(N(c3ccc(/C=C/c4cccc(C)c4)cc3)c3ccc(/C=C/c4cccc(C)c4)cc3)cc2)c1 ; Cc1cccc(/C=C/C=C/c2ccc(N(c3ccc(/C=C/C=C/c4cccc(C)c4)cc3)c3ccc(/C=C/C=C/c4cccc(C)c4)cc3)cc2)c1 ; CCc1cccc(C)c1N(c1ccc(/C=C/c2ccccc2)cc1)c1ccc(-c2ccc(N(c3ccc(/C=C/c4ccccc4)cc3)c3c(C)cccc3CC)cc2)cc1]

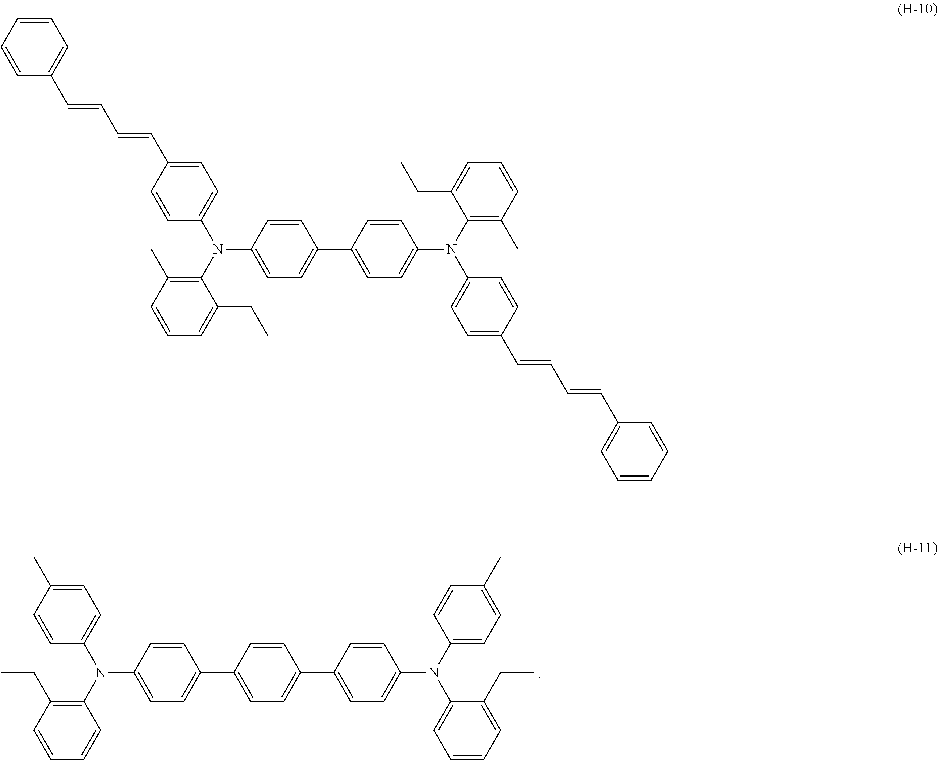 [SMILES: CCc1cccc(C)c1N(c1ccc(/C=C/C=C/c2ccccc2)cc1)c1ccc(-c2ccc(N(c3ccc(/C=C/C=C/c4ccccc4)cc3)c3c(C)cccc3CC)cc2)cc1 ; CCc1ccccc1N(c1ccc(C)cc1)c1ccc(-c2ccc(-c3ccc(N(c4ccc(C)cc4)c4ccccc4CC)cc3)cc2)cc1]

10. The electrophotographic apparatus according to claim 1, wherein the charge generating substance contains titanyl phthalocyanine.

11. The electrophotographic apparatus according to claim 1, wherein the photosensitive layer contains, as an additive, a compound represented by the following formula (T-1):

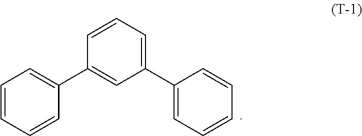 [SMILES: c1ccc(-c2cccc(-c3ccccc3)c2)cc1]

12. The electrophotographic apparatus according to claim 1, wherein the corona charger is a scorotron charger including a discharge electrode and a grid.
